(19) United States
(12) Patent Application Publication
(10) Pub. No.: US 2024/0210434 A1
(43) Pub. Date: Jun. 27, 2024

(54) INTEGRATED SILICON PHOTONIC BIOSENSORS FOR PLATE READERS, AND RELATED SYSTEMS AND METHODS

(71) Applicant: SiPhox, Inc., Burlington, MA (US)

(72) Inventors: Michael Zalmon Dubrovsky, Burlington, MA (US); Azra Horowitz, Burlington, MA (US); Nithin Parsan, Burlington (YS); Diedrik Rene Vermeulen, Burlington, MA (US)

(73) Assignee: SiPhox, Inc., Burlington, MA (US)

(21) Appl. No.: 18/421,547

(22) Filed: Jan. 24, 2024

Related U.S. Application Data
(63) Continuation of application No. PCT/US22/37770, filed on Jul. 20, 2022.
(60) Provisional application No. 63/223,800, filed on Jul. 20, 2021.

(51) Int. Cl. G01N 35/10; B01L 3/00; G01N 35/00

(52) U.S. Cl. CPC G01N 35/1074; B01L 3/502715; B01L 2200/04; B01L 2200/0642; B01L 2300/0654; G01N 2035/00524; G01N 2035/1032

(57) ABSTRACT

Disclosed herein are automated biosensing devices for biosensing including a set of sensor units organized in an array. Each of the sensor units includes an optical reader optically coupled to a corresponding sensor photonic integrated circuit (PIC). Each sensor PIC includes one or more optical analyte sensors each functionalized by a respective layer of binding ligands. Each optical reader is configured to provide optical signals to the one or more optical analyte sensors of the corresponding sensor PIC. An automated biosensing device can further include a robotic dipping head configured to dip each of the sensor PICs into a respective test sample.

### CROSS-REFERENCE TO RELATED APPLICATIONS

This application claims priority to PCT Application No. PCT/US2022/037770, titled “INTEGRATED SILICON PHOTONIC BIOSENSORS FOR PLATE READERS, AND RELATED SYSTEMS AND METHODS” and filed Jul. 20, 2022, which claims priority to U.S. Provisional Application No. 63/223,800 titled “Automatic Dipping Head Coupled to Integrated Photonic Biosensors” and filed Jul. 20, 2021, each of which is incorporated herein by reference in its entirety.

### FIELD OF THE INVENTION

The present disclosure is directed to integrated photonic systems and methods for biosensing and, more specifically, integrated photonic systems and methods for automatically performing many chemical and biochemical assays simultaneously.

### BACKGROUND

Robotic dipping heads and similar instruments have become widely available. Current automated liquid handling systems are most often used on simple pipetting workflows like well plating, serial dilutions, etc. Incorporating automated liquid handling systems into more complicated chemical and biological processes is of significant interest.

### SUMMARY OF THE DISCLOSURE

In one aspect, the disclosure features automated biosensing devices. An example automated biosensing device can include a set of sensor units organized in an array. Each of the sensor units can include an optical reader optically coupled to a corresponding sensor photonic integrated circuit (PIC). Each sensor PIC can include one or more optical analyte sensors each functionalized by a respective layer of binding ligands. Each optical reader can be configured to provide optical signals to the one or more optical analyte sensors of the corresponding sensor PIC. The automated biosensing device can further include a robotic dipping head configured to dip each of the sensor PICs into a respective test sample.

Various embodiments of the automated biosensing devices can include one or more of the following features.

The automated biosensing device can father include a gantry head configured to control the dipping head to move in at least two dimensions. Each of the optical readers can be mounted on the gantry head. The automated biosensing device can further include a rack. Each of the optical readers can be mounted on the rack. Each of the optical readers can be further configured to receive optical signals provided by the one or more optical analyte sensors of the corresponding sensor PIC via one or more optical fibers.

The set of sensor units includes a particular sensor unit can include a particular optical reader optically coupled to a particular sensor PIC having one or more particular optical analyte sensors. The particular optical reader can be coupled to one or more processing devices configured to determine one or more characteristics of one or more analytes sensed by the one or more particular optical analyte sensors based on the optical signals provided by the one or more particular optical analyte sensors.

Each of the optical readers can be a first optical reader, and each of the sensor units can further include a second optical reader co-located with the sensor PIC of the sensor unit. The set of sensor units can include a particular sensor unit comprising a particular first optical reader, a particular second optical reader, and a particular sensor PIC having one or more particular optical analyte sensors. The particular second optical reader can be configured to receive optical signals provided by the one or more particular optical analyte sensors via one or more optical waveguides, generate raw data based on the optical signals provided by the one or more particular optical analyte sensors, and send the raw data to the first particular reader PIC. The second particular reader can be configured to send the raw data to the first optical reader via one or more electrical wires.

The automated biosensing device can further include a shaker configured to shake each of the test samples, wherein each of the test samples is disposed in a well of the well plate. Each optical reader can be configured to interrogate the one or more optical analyte sensors of the corresponding sensor PIC while the corresponding sensor PIC is dipped in the corresponding test sample and while the shaker shakes the corresponding test sample.

The set of sensor units includes a particular sensor unit can include a particular optical reader optically edge coupled to an edge of a particular sensor PIC. The one or more optical analyte sensors of the particular sensor PIC can be disposed on one or more surfaces of the
particular sensor PIC that are orthogonal to the edge of the particular sensor PIC. Each of the sensor PICs can be connected to the corresponding optical reader through a pluggable connector.

The automated biosensing device can further include an automated liquid handing mechanism configured to inject the test samples into respective wells of a well plate. Each of the sensor PICs can be a component of a respective non-microfluidic cartridge.

In another aspect, the disclosure features biosensing methods. An example biosensing method includes placing one or more test samples into one or more respective wells of a well plate. The method can further include, with a dipping head of an automated biosensing device, dipping one or more sensor photonic integrated circuits (sensor PICs) into the one or more respective test samples. Each sensor PIC can be optically coupled to a corresponding optical reader, and each sensor PIC comprises one or more optical analyte sensors each functionalized by a respective layer of binding ligands. The method can further include, with each optical reader, interrogating the corresponding sensor PIC by providing optical signals to the one or more optical analyte sensors of the corresponding sensor PIC. The method can further include, for each sensor PIC, receiving optical signals provided by the one or more optical analyte sensors of the sensor PIC, and determining one or more characteristics of one or more analytes sensed by the one or more optical analyte sensors based on the optical signals provided by the one or more optical analyte sensors.

The foregoing Summary, including the description of some embodiments, motivations therefore, and/or advantages thereof, is intended to assist the reader in understanding the present disclosure, and does not in any way limit the scope of any of the claims.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1 is a diagram of a perspective view of an example integrated photonics assembly that multiple photonic integrated subcircuits.

FIG. 2 is a diagram of a top view illustrating light transfer between example subcircuits of an integrated photonics assembly.

FIGS. 3A-3C are diagrams of top views of example integrated photonics assemblies, which each include multiple subcircuits.

FIG. 4 is a diagram of a top view of an example packaged ID integrated photonics assembly.

FIG. 5 is a diagram of a top view of an example packaged pseudo-2D integrated photonics assembly.

FIG. 6 is a diagram of an integrated photonic system for biosensing including an interrogator and cartridge.

FIG. 7 is a flowchart of a method for biosensing utilizing the integrated photonic system.

FIG. 8 is a diagram of a packaged integrated photonic system for biosensing.

FIGS. 9-10 are diagrams of embodiments of an interrogator.

FIGS. 11A-11C are diagrams of embodiments of an alignment module.

FIG. 12 is a diagram of an embodiment of a stage, which enables the efficient and easy replacement and/or alignment of the cartridge.

FIG. 13 is a diagram of an example cartridge, which may be an assembly including a sensor chiplet and one or more microfluidic cells.

FIG. 14 is a perspective rendering of various components associated with the photonic biosensing platform.

FIG. 15 is a perspective rendering of the example tabletop apparatus of FIG. 14, including a display, disposable test cartridges, apparatus input ports, and buttons.

FIG. 16 is a perspective rendering of the example portable apparatus of FIG. 14, and related components, and the display and related software of FIG. 14.

FIG. 17 is a perspective rendering of the example handheld apparatus of FIG. 14 optically coupled to a cartridge.

FIG. 18 is a close-up view of an example cartridge of FIG. 15 configured to be inserted into the tabletop apparatus or handheld apparatus.

FIGS. 19A-19D are renderings of four implementations of a biosensor chip with microfluidics that may be used within a test cartridge.

FIG. 20A is a diagram of the sensor chiplet having a waveguide including antibodies in at least one channel.

FIG. 20B is a diagram of a Mach-Zender Interferometer (MZI)-type sensor.

FIG. 20C is a diagram of an absorption spectroscopy type sensor.

FIG. 21A is a diagram of an example method where an antigen binds to an antibody immobilized on a ring resonator.

FIG. 21B is a diagram of an example process wherein the cleaving agent cleaves a reporter probe from a waveguide.

FIG. 22 is a diagram of an example testing mechanism used by the biosensing apparatus.

FIG. 23 is a diagram of a cleaving component configured to be activated when it detects a sensing target of interest.

FIG. 24 is a diagram illustrating the example target-specific cleavage process.

FIG. 25 is a diagram of an example method for RNA detection using a toehold switch RNA approach.

FIG. 26 is a diagram of an example method for DNA and RNA detection using CRISPR and a waveguide.

FIG. 27 is a diagram of an example method attaching a magnetic particle to a sensing target that may direct the sensing target to the waveguide via an applied magnetic field.

FIG. 28 is a diagram of an example microfluidic channel that transports analyte to the waveguide.

FIG. 29 is a diagram of an example implementation of the multi-photonic-chiplet (MPC)-based optical biosensor assembly for multiplexed sensing of analytes.

FIG. 30 is a diagram of an example layout of the photonic biosensor with a single sensing element.

FIG. 31A is a diagram of an example system including the sensing element(s) and the frequency discriminator.

FIGS. 31B-31C is a plot illustrating the functionality of the sensing elements and frequency discriminator of FIG. 31A.

FIG. 32A is a diagram of an example implementation of an automated biosensing system with multiple sensor chiplets capable of performing multiple tests within a multi-well plate.

FIG. 32B is an example architecture of an automated biosensing system with multiple sensor chiplets capable of performing multiple tests within a multi-well plate.

FIG. 32C is an example architecture of an automated biosensing system capable of performing a single test using a single sensor chiplet.

FIG. 32D is a graph illustrating the resonance shift for samples tested using an automated biosensing system.

FIG. 33A is a diagram of mechanical alignment between a robot arm and a disposable sensor tip to enable optical communication between the reusable arm having reusable optical components and the disposable sensor chiplets on the sensor tips.

FIG. 33B is a diagram illustrating an automated biosensing system with a disposable sensor chiplet.

FIG. 34 is a perspective rendering of an example implementation of automated liquid handling to insert sample tests directly into the disposable sensors coupled to a tabletop biosensing platform.

FIG. 35 is a diagram of an example implementation of an automated liquid handling system to draw samples into tubes and flow them over sensor chips via microfluidic channels.

FIG. 36 is a pair of graphs illustrating resonance peaks for a sample that has been tested with or without shaking.

FIG. 37 is a graph illustrating a blue shift of the resonance peaks when samples are measured in deionized water when compared to salt water.

FIG. 38 is a diagram of an example sensor chip with edge facets of waveguides used for biolayer interferometry. The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

### 1. Photonic Integrated Circuits (PICs)

Some embodiments of the biosensors described herein include one or more photonic integrated circuits. Some examples of photonic integrated circuits and sensing devices incorporating photonic integrated circuits are described below.

Disclosed herein are embodiments of photonic integrated subcircuits that can be assembled into an integrated photonics assembly. These photonic integrated subcircuits may be referred to herein as “subcircuits,” “chiplets,” or “sub-chips.” The integrated photonics assembly may be referred to herein as “an assembly,” “an integrated photonics assembly,” or “a photonic integrated circuit” (PIC). In some cases, a PIC may include two or more photonic integrated subcircuits. In some cases, a PIC may consist of a single photonic integrated subcircuit.

A given photonic integrated subcircuit can be configured to transfer light to and/or receive light from at least one other subcircuit, for example, using one or more light transfer techniques. In various embodiments, each photonic integrated subcircuit is a discrete integrated circuit or chip that can be physically separated from one another, moved, and/or attached to one another. The example subcircuits can be assembled to create a larger integrated photonics circuit using two or more subcircuits. The example subcircuits can be used to extend and/or combine an integrated photonic circuit into a larger integrated photonic circuit. The example subcircuits are configured to guide light via waveguide structures and may contain special functions including, e.g., splitting light, wavelength demultiplexing, photo detection, light generation, light amplification, etc.

A sensor chip may include one or more biosensing photonic circuits. As used herein, “optical analyte sensor” may refer to an individual biosensing photonic circuit capable of sensing (e.g., functionalized to sense) a specific analyte. In some embodiments, a sensor chip may include between 1 and 1,000 optical analyte sensors or more. In some embodiments, two or more optical analyte sensors may be used in combination to sense a single, specific analyte. In some cases, two or more optical analyte sensors may sense the same analyte, and the signals sensed by those sensors may be averaged. In some cases, an optical analyte sensor may be used to sense a negative control, which can then be subtracted (or otherwise removed) from the signals sensed by other sensors.

Each optical analyte sensor can be functionalized (e.g., printed) with a capture ligand (also referred to as ‘binding ligand’ or simply ‘binder’) capable of binding a target analyte. For example, an optical analyte sensor may be functionalized to detect a target analyte by coating the optical analyte sensor with a layer of binding ligands (e.g., antibodies, aptamers, peptides, enzymes, Oligonucleotides, scFV synthetic antibody fragments, etc.) or other binding materials suitable for binding to the target analytes.

### 1.1. Standardization of Photonic Integrated Subcircuits

In various embodiments, each subcircuit is a pre-fabricated integrated circuit. By prefabricating the subcircuits, the subcircuits can be standardized so as to enable assembly of two or more subcircuits into a PIC. Standardization of subcircuits can pertain to one or more properties of the subcircuits, including dimension(s), volume, weight, input(s), output(s), functionality, mechanical feature(s) (e.g., for coupling, alignment, etc.), active alignment feature(s), wirebond pad(s), electrical connection(s), feature(s) that are complementary to a receptacle (including vertical alignment feature(s) and/or lateral alignment features), etc. Standardization can include the configuration of complementary properties or structures of two or more adjacent subcircuits, as described further below. For instance, alignment structures and/or waveguide paths in a first type of subcircuit may be configured to be complementary with respective alignment structures and/or waveguide paths in a second type of subcircuit, such that a subcircuit of a first type can be attached to a subcircuit of a second type, e.g., with low optical loss. Standardization of the subcircuits can enable permutational assembly of the subcircuits into PICs. Further, standardization can enable time-efficient and/or cost-efficient packaging.

Because many different types of integrated photonics assembly can be created from the subcircuits, it is beneficial to standardize the subcircuits. One benefit of standardization is that a subcircuit can be switched or interchanged with another subcircuit, thereby creating a different optical assembly that is a variation of the first assembly. In some embodiments, subcircuits can be configured such that they enable many optical assemblies that are useful with a minimum number of subcircuits. Further, each subcircuit or type of subcircuit can be configured and/or selected for improved performance, reduced cost, efficiency or ease of fabrication, efficiency or ease of supply, etc.

There is generally a nonzero likelihood that certain aspects and/or components (e.g., transistors) of an integrated circuit may fail or render the individual fabricated circuit defective. The resulting integrated circuits of a particular fabricated batch that function correctly is the “yield” of that particular batch. By fabricating (and subsequently testing) the integrated photonics subcircuits individually and/or independently, the non-functioning subcircuits can be eliminated from the supply of subcircuits. Further, it is found that a higher number of functioning subcircuits (of a given type) can be produced using a single type of fabrication process (e.g., on a given wafer). In comparison, a mixed-type integrated circuit (e.g., using more than one type of fabrication process) results in lower yield of that mixed-type integrated circuit. This results in a higher number of fully-functioning integrated subcircuits, thereby contributing to an increased number of integrated photonics assemblies. Therefore, In some embodiments, it may be preferrable to generate an integrated optical circuit from subcircuits even if all the component subcircuits can be fabricated in the same process. This can increase the number of optical assemblies that can be built. Furthermore, the subcircuits can be yielded before they are used in the optical assembly, thereby increasing the total yield of a certain optical assembly. The optical assembly can thus be yield-optimized by forming the assembly from different sub-chips.

In some embodiments, yields are significantly improved in an integrated photonics assembly as compared to a monolithic chip. In some embodiments, cost is significantly reduced in an integrated photonics assembly as compared to a monolithic chip.

In some embodiments, subcircuits are standardized in size. For example, a standardized set of subcircuits may include subcircuits that are each 1 mm in width and 1 mm in length. In some embodiments, the standardized set may include two or more subsets of subcircuits in which the size of subcircuits in each subset is standardized. For example, a first subset may have subcircuits of 1 mm×1 mm, a second subset of subcircuits of 1 mm×2 mm, a third subset of subcircuits of 2 mm×2 mm, a fourth subset of subcircuits 1 mm×3 mm, etc.

In some embodiments, the subcircuits are standardized according to the light port positioning and/or electrical pad positioning. For instance, the position of light input ports and/or output ports along the edges or surface of the subcircuits may be standardized for groups of subcircuits. By leveraging standardization, a library of standard subcircuits can be produced to build nearly an endless variety of photonic assemblies without the need for costly or time-consuming customization of the package or assembly process.

In some embodiments, the standardization of subcircuits contributes to and/or directly begets the standardization of other components, e.g., printed circuit boards (PCBs), non-optical components, lasers, etc. For example, by standardizing the electrical pads in a subcircuit, connecting pads on a host PCB can also be standardized, thereby contributing to greater efficiency.

### 1.2 Modularity of Photonic Integrated Subcircuits

Importantly, each subcircuit may be configured to be a modular component of an integrated photonics assembly. The modular character of the subcircuits is one benefit of the standardization of the subcircuits. For instance, two or more subcircuits, e.g., subcircuits Si and S2, can be assembled into assembly A with functionality FA. One or more of these subcircuits (e.g., subcircuit S2) can be removed from assembly A and connected to another subcircuit (e.g., subcircuit S3) and/or an assembly to form assembly B, in which assembly B has a functionality FB (which may be different from functionality FA). In doing so, the subcircuits' modular character enables many useful integrated optical assemblies.

Various benefits flow from the modularity of the photonic integrated subcircuits. In particular, the modularity of the subcircuits facilitates the scaling (e.g., scaling up or down) of integrated photonics assemblies, replacement of subcircuits of an assembly, improvements to existing PICs, reconfigurability of assemblies, etc. Importantly, the described systems and methods can produce the desired subcircuits and/or customized integrated photonics assemblies faster than the fabrication of a conventional PIC. For example, a customized integrated photonics assembly may be produced within seven (7) days as compared to the one (1) year required for the conventional PIC. Accordingly, the described systems and methods enable efficiencies in time and/or cost.

Further, the modular subcircuits can reduce waste. For example, as described below, the described systems and methods permit the reuse of existing subcircuits and/or reconfiguring of existing assemblies. In another example, the described techniques enable the fabrication of subcircuits on demand (and therefore a reduction of inventory).

In some embodiments, when a particular subcircuit S in a given assembly is discovered to be faulty (e.g., inefficient, inoperable, incompatible, etc.), that particular subcircuit S may be removed from the assembly and a replacement subcircuit S′ may be installed in its place. In another example, the particular subcircuit S may need to be reconfigured and/or translated to another portion of the assembly to be operable. This has the advantage of avoiding disturbing the rest of the assembly while providing a quick and/or simple solution to replacing a faulty part of the assembly. By contrast, a conventional PIC—which requires a single indivisible “chip”—may not be repairable by swapping out or reconfiguring of a faulty component.

The modularity of the subcircuits can facilitate the evolution of engineering and/or design of integrated photonics assemblies over time. The development of an assembly A having a particular functionality may change from a first generation (e.g., assembly A₁) configuration to a second generation (assembly A₂), third generation (assembly A₃), and so on to accommodate the needs of customers and/or adapt to changing markets, new technologies, different materials, different standards, a change in specifications, evolving regulation, etc. This may be achieved by adding, replacing, moving, reconfiguring, etc. one or more subcircuits in the assembly (e.g., assembly A₁) to produce another assembly (e.g., assembly A₃). For example, at some time after the production of the first generation assembly A₁, a new subcircuit may become available. This new subcircuit may be added to or replace an existing subcircuit in the first generation assembly A₁ to form the second generation assembly A₂.

In some embodiments, an existing assembly A may be repurposed or adapted with a different functionality by changing one or more subcircuits included in the assembly A. In another example, a conventional PIC may be repurposed or reconfigured with a different functionality by adding one or more subcircuits to the PIC. In such a case, an adapter-type subcircuit may be coupled to the conventional PIC and one or more subcircuits may be coupled to the adapter-type subcircuit. In another embodiment, two or more assemblies may be coupled together by one or more subcircuits, e.g., forming a light path between the two or more assemblies.

One characteristic of an integrated photonics chip (or subchip) is its ability to guide light. In various embodiments, the subcircuits can be fabricated from one or more electro-optic crystals, polymers, and/or semiconductor materials. For example, this can be achieved in a CMOS-compatible sub-chip or so-called silicon photonics, silicon-on-silica, silicon nitride, aluminum oxide, glass, III/V based integrated photonics chips, lithium niobate, silicon-on-insulator, gallium arsenide (GaAs), indium phosphide (InP), nitride, glass, etc. In some embodiments, the subcircuit is a combination of subcircuits. For example, a silicon photonics subcircuit can be enhanced with a III/V chip to increase its functionality (e.g., optical detection and optical gain), thereby creating a subcircuit that includes two or more chips or subchips.

The example integrated photonics assemblies may be configured for one or more functionalities. The assemblies may be configured for communication, biomedical, chemical, research, computing, or other applications. A non-limiting list of applications include beamforming, beam-steering, LiDAR, biomedical instrumentation (OCT, spectrometers, diagnostics, etc.), biophotonics (blood analysis, brain control, etc.), acousto-optics, astrophotonics, gyroscopes, metrology, optical clocks, magneto-optics (integrated magneto optical devices, isolators, memory, switches, etc.), artificial intelligence, reconfigurable photonic processors, THz photonics, microwave photonics, fiber sensor interrogators, free-space optical communication (Li-Fi, satellite Internet, etc.), augmented reality, quantum optics (QKD, QRNG, etc.), etc.

### 1.3 Light Transfer Techniques

Light may be transferred and/or received between two or more subcircuits using one or more light transfer methods, as described in further detail below. Each subcircuit can transfer light to at least one other subcircuit. In some embodiments, electrical signals, microwave signals, and/or fluids may be transferred and/or received by the subcircuits. In various embodiments, the wavelength of the light can span from 100 nm to 20 microns. Light can be transferred and/or received over one or more channels. In some embodiments, a given channel transmits light in one or more wavelengths, one or more polarizations, and/or one or more modes.

In various embodiments, a subcircuit can be as close as zero (0) micron distance edge-to-edge with another subcircuit. This can be true when two or more subcircuits are stacked horizontally, stacked vertically, or configured to be partially overlapping (e.g., negative distance edge to edge). In various embodiments, the maximum distance between light-transferring subcircuits can be as large as 10 cm. In some embodiments, the distance is between 0 um and 2 mm.

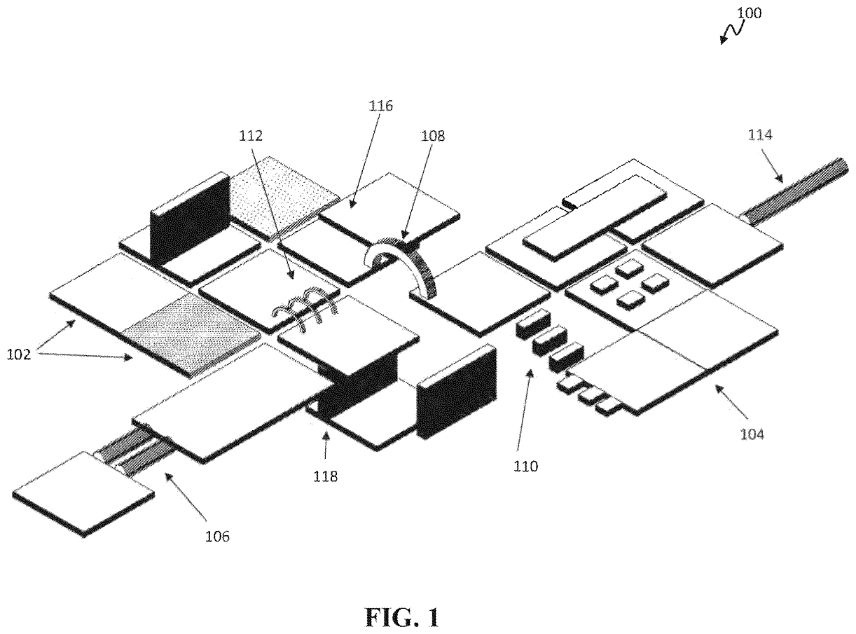

In various embodiments, an integrated photonics assembly can include two or more photonic integrated subcircuits. FIG. 1 illustrates an example integrated photonics assembly 100 that includes multiple subcircuits 102. As depicted, the subcircuits 102 can be coupled to one another by one or more techniques. For example, light can be transferred between two or more subcircuits via butt-coupling 104, optical fiber(s) 106, photonic wirebond(s) 108, a free-space optical train 110, electrical wirebonds 112, adiabatic coupling, out-of-plane coupling, etc. In various embodiments, the integrated photonics assembly 100 can be optically connected to an external system (e.g., a subcircuit, another assembly, a conventional PIC, an electrical system, a computing system, a biomedical system, etc.) by an optical fiber 114. In various embodiments, a channel between two subcircuits can transfer light of one or more polarizations, one or more modes, and/or one or more wavelengths.

The example subcircuits may be arranged in various configurations, e.g., side by side, overlapping, etc. For example, one or more subcircuits can be connected on top of, under, or to the side of a host subcircuit. In some embodiments, a host-type subcircuit is larger in at least one dimension than at least one other type of subcircuit so as to provide sufficient space to “carry” a number of subcircuits. In some embodiments, a host-type subcircuit is smaller in at least one dimension than at least one other type of subcircuit so as to act as a “bridge” between two or more subcircuits. Note that, in the drawings, some subcircuits are distinguished by different patterned or colored surfaces to indicate different types or functionalities.

Light transfer can be accomplished by any one or more of the following techniques. In some embodiments, light is transferred by edge-to-edge coupling (also referred to as butt coupling) between two or more subcircuits (refer to arrow 104). In this technique, light abruptly exits the subcircuit (e.g. via the end of a light path, waveguide, from an output port, etc.) from one side or edge of the subcircuit into air or any other bulk medium. Light can enter abruptly into the side or edge (e.g., via the beginning of a light path, waveguide, into an input port, etc.) of another subcircuit.

In some embodiments, light is adiabatically transferred between subcircuits by a taper system or method. In this technique, two subcircuits are configured to overlap at least partially (refer to arrow 116). In at least one of the subcircuits, the geometry of a waveguide can be configured such that light can be transferred adiabatically or near-adiabatically to another subcircuit.

In some embodiments, light is transferred between subcircuits via an optical guiding medium. Such optical guiding mediums can include an optical fiber 106, a polymer waveguide, a polymer fiber, etc. The light may be guided in the region or space between the subcircuits and may therefore bridge a larger distance with lower optical loss (as compared to subcircuits without the optical guiding medium). In some embodiments, light is transferred in free-space or in a medium via a crossing lens, a collimator, etc.

In some embodiments, light is configured to exit a subcircuit non-horizontally (e.g., near-vertically or vertically) and enter non-horizontally into another subcircuit. In one example, integrated mirrors or grating couplers can be used to accomplish this type of light transfer. In some embodiments, light exits one subcircuit non-horizontally and enters another subcircuit horizontally. In one example, this is achieved by a subcircuit standing vertically on the surface of another sub-chip (illustrated by arrow 118).

The transfer of light between two or more subcircuits can involve any one or combination of the above-described light transfer methods. In some embodiments, light transfer can involve two or more methods (or combinations of methods) for two or more respective channels. Using two or more methods of transferring light can be particularly useful in some cases. In one scenario, butt-coupling of subcircuits may be preferred but a particular routing or direction of the light transfer path may be difficult or may require customization. Such routing can be achieved by using a flexible connection, e.g., a polymer waveguide or a photonic wirebond. In some instances, some subchips may not be identically sized or shaped due to imperfect dicing or cleaving. Therefore, gaps between such subchips can be spanned using a flexible interconnection method.

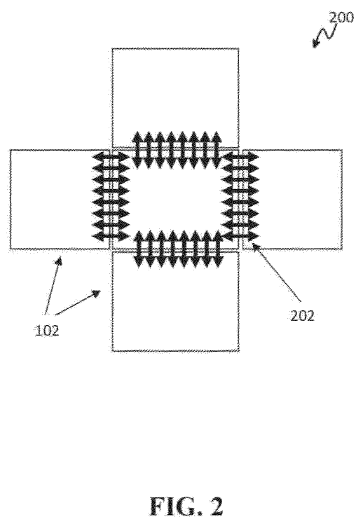

In some embodiments, transfer of light between subcircuits is multi-channel. One benefit of subcircuits that are closely spaced is that many light transfers can happen between the two subcircuits at the same time. As an example, a single subcircuit can transfer light to 10 or more other subcircuits with 100 light channels between each sub-chip. Other free-space components may be added in between the subcircuits and in between the optical path(s). FIG. 2 illustrates light transfer between subcircuits of assembly 200. The assembly 200 includes five (5) subcircuits 102, among which light is transferred and/or received. In the illustrated example, the subcircuits are butt-coupled, thereby making a large number of light transfer paths 202 feasible.

In some embodiments, some chips do not transmit light to a subcircuit and therefore be referred to as “non-photonic subcircuits” or “non-photonic subchips.” For instance, such non photonic subchips may only transmit and/or receive electrical signals from a photonic assembly of subcircuits. Accordingly, these may not be considered a part of the integrated photonics assembly. However, in some embodiments, these non-photonic subchips are part of a standardized package around the integrated photonics assembly.

In various embodiments, light can be transmitted from the integrated photonics assembly to an external or remote device or system. In some embodiments, this light may eventually reach other optical chips, though these other chips may not be considered part of the optical assembly. Subcircuits may have light paths to an external system by, for example, a fiber, fiber array or free-space connection. There is no lower bound or upper bound on the number of subcircuits that need to be connected from the assembly to the outside world (e.g., an external system or device) and no limitation on which method is used.

### 1.4. Integrated Photonics Assemblies

As described above, subcircuits can be combined in many different assemblies and configurations. Subcircuits may be combined in a one-dimensional, two-dimensional, or three-dimensional assembly using any one or more of the techniques described herein.

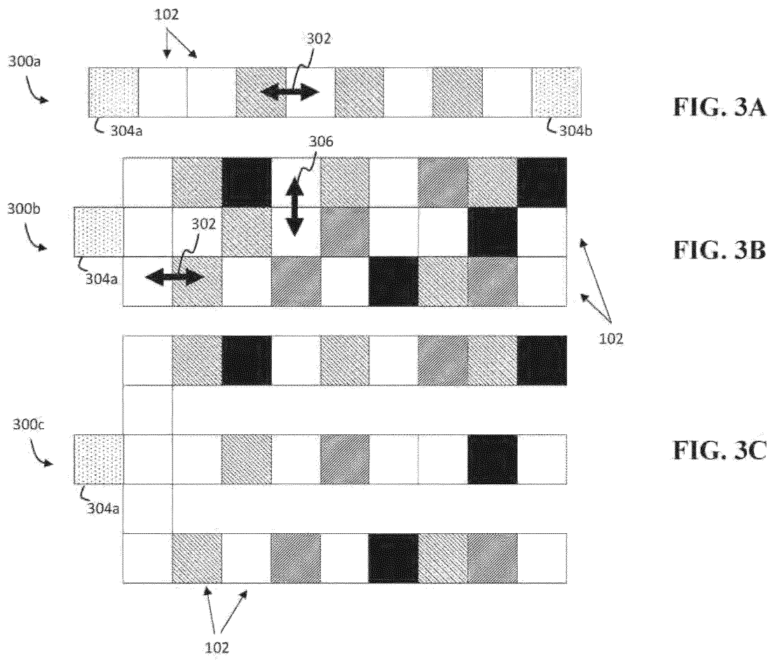

FIGS. 3A-3C provide examples of integrated photonics assemblies, which each include multiple subcircuits 102. In particular, FIGS. 3A-3C illustrate the modular properties of the subcircuits, including how the subcircuits can be arranged (e.g., coupled, connected, stacked, etc.) and how the photonics assembly can be standardized. Note that, in these examples, the subcircuits are configured to be the same size (in at least two dimensions) and shape.

FIG. 3A illustrates a one-dimensional (1D) array 300a (also referred to as 1D-stacking). In this case, light can be transferred left or right (indicated by arrow 302) between at least a subset of the subcircuits 102. The array 300a may begin with a subcircuit 304a and/or end with a subcircuit 304b. In some embodiments, subcircuits 304a and/or 304b may be able to transfer light to one other subcircuit and/or from one edge of the subcircuit. To enable efficient light transfer between two or more subcircuits 102, the position of the light path within the subcircuits can be standardized to increase assembly permutations, as discussed in more detail herein.

FIG. 3B illustrates an example two-dimensional (2D) array 300b of subcircuits, which includes subcircuits configured with light transfer paths oriented up and down (indicated by arrow 306 and referred to as north and south). FIG. 3C illustrates an example “pseudo” 2D array 300c, which can be considered an extension of the 1D array. The example array 300c enables multiple parallel circuits to be connected together without requiring north and south light transfer capability on most subcircuits.

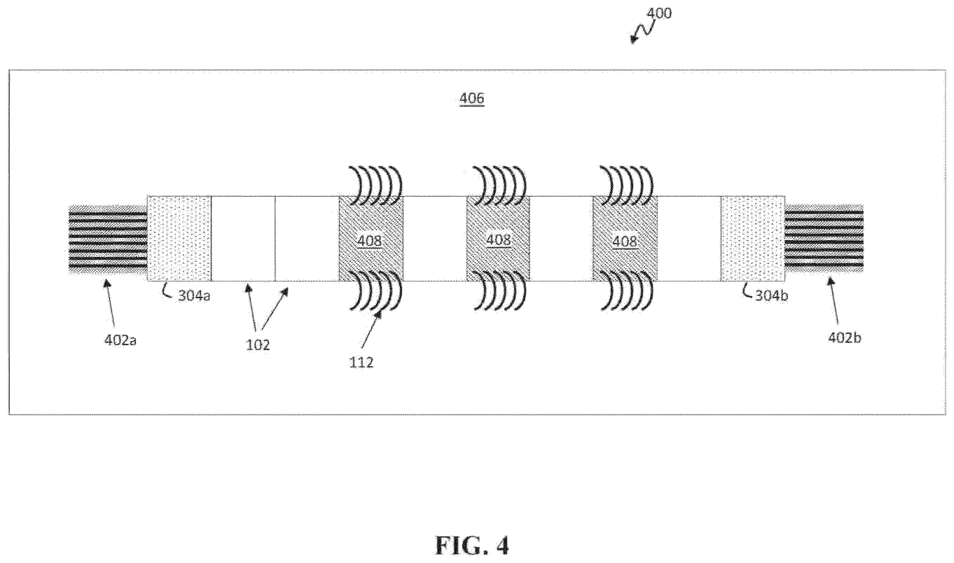

FIG. 4 illustrates an example of a packaged 1D integrated photonics assembly 400. The assembly 400 includes multiple subcircuits 102, a first fiber array 402a connected to the first subcircuit 304a, and a second fiber array 402b connected to the last subcircuit 304b. Note that a subset of the subcircuits are wirebonded via electrical conductors 112 to the printed circuit board (PCB) 406. Wirebonds 112 can be created during the fabrication and/or assembly process. The electrical wirebonds 112 may be standardized such that they can be connected to a particular type of subcircuit 408. Such subcircuits 408 may be configured to handle both light and electrical current.

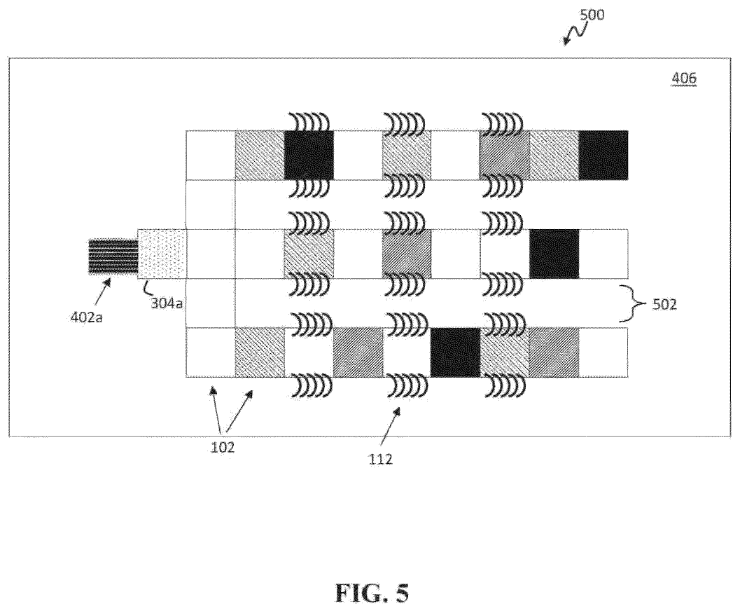

FIG. 5 shows an example of a packaged pseudo-2D integrated photonics assembly 500. A fiber array 402a is connected to the first subcircuit 304a. In this example, because there are empty spaces 502 between parallel rows of subcircuits, the subcircuits are accessibly wirebonded via wirebonds 404 to the PCB 406. Note that the empty spaces 502 can contribute to the standardization of the host PCB by providing space for electrical pads on the PCB via the empty spaces 502.

The packaged integrated photonics assemblies illustrated in FIG. 4 and FIG. 5 are for illustrative purposes and not for limitations. In real applications, a packaged integrated photonics assembly can be organized into many different ID, 2D, or even 3D structures and can include a large variety of numbers of subcircuits. In some embodiments, a packaged integrated photonics assembly can be cut to a standard size to facilitate integration, replacement, and the like.

### 2 Integrated Photonic Systems and Methods for Biosensing

Described herein are various embodiments of integrated photonic systems and methods for biosensing. In some embodiments, integrated photonic biosensors can combine high-sensitivity analysis with scalable, low-cost complementary metal-oxide-semiconductor (CMOS) manufacturing. The biosensors may be implemented in portable, highly-accessible, and easy-to-use devices. Example integrated photonic biosensors can include one or more photonic integrated subcircuits, as described above.

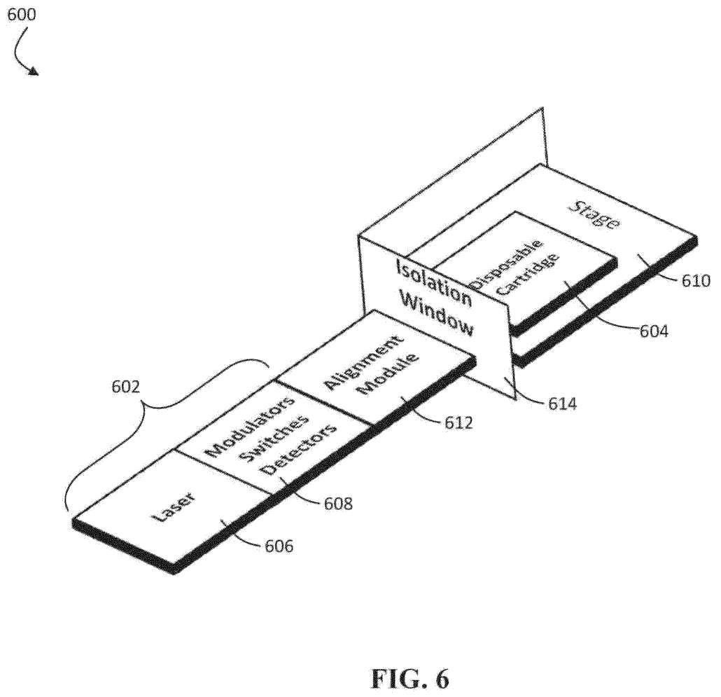

FIG. 6 illustrates an embodiment of an integrated photonic system 600 for biosensing including an interrogator (or “optical reader”) 602 and cartridge 604. The interrogator 602 may be an assembly including one or more photonic integrated subcircuits, which may each be active or passive. These subcircuits may be packaged together or may be modular. The interrogator 602 may include a light source 606 (e.g., a laser) configured to generate a light. A photonic integrated subcircuit may be edge-coupled to the light source 606 and can include one or more light paths (e.g., waveguides) configured to carry light. The interrogator 602 can include a control circuit 608 to control the light in the light paths of the interrogator 602. In some embodiments, the interrogator 602 may be coupled to an interface to provide an electronic and/or visual readout to a user of the system 600.

The interrogator 602 can be optically coupled to the cartridge 604. The cartridge 604 can be configured to receive a biological sample (e.g., a biological fluid). The light from the
interrogator 602 can be used to determine one or more characteristics of the biological sample in the cartridge 604. In some embodiments, the cartridge 604 includes a sensor photonic integrated subcircuit (also referred to as a “sensor subchip”, “sensor chiplet” or simply as “sensor”). In some embodiments, the cartridge 604 includes a sensor photonic integrated circuit (also referred to as a “sensor PIC” or “sensor assembly”). In some embodiments, the cartridge 604 includes a microfluidic cell. The microfluidic cell may include one or more proteins (e.g., antigens), one or more reagents, one or more rinsing fluids, etc. The microfluidic cell may include a magnetic microstirrer, a plasmonic vortex mixer, and/or a flow-inducing device. For example, the microfluidic cell may leverage a mixing mechanism or a flow-inducing mechanism to ensure sufficient interaction between the analyte and the sensor chiplet surface. In some embodiments, the microfluidic cell may include a microstirrer and a transmitter (e.g., a magnetic field generator) configured to power the magnetic microstirrer. Note that the cartridge 604 can be separately packaged (e.g., in a housing) from the other components in the system 600.

In some embodiments, a cartridge does not include any microfluidic cells, does not control or use any microfluidic cells to promote interaction between the analyte and the sensor chiplet surface, is not in fluid communication with any microfluidic cells, and/or does not have a microfluidic cell disposed between the sensor chiplet surface and the sample (or interstitial fluid). Such cartridges may be referred to herein as non-microfluidic cartridges. When a non-microfluidic cartridge is used, interaction between the analyte and the sensor chiplet surface may be induced by immersing the sensor chiplet in the interstitial fluid or sample of interest. In some cases, further interaction between the analyte and the sensor chiplet surface may be induced by shaking, stirring or otherwise inducing flow of the sample, or by shaking the sensor chiplet. One of ordinary skill in the art will appreciate that a non-microfluidic cartridge can be coated with one or more materials that facilitate interaction between the analyte and the sensor chiplet surface.

In some embodiments, system 600 can include a stage 610 configured to removably engage the cartridge 604. For instance, the cartridge 604 may be positioned such that it is temporarily secured (e.g., mechanically) on the stage 610. The stage 610 may facilitate alignment (e.g., mechanically) of a light path of the interrogator 602 and the light path of the cartridge 604. In some embodiments, the stage 610 can include a thermoelectric heater and/or thermoelectric cooler.

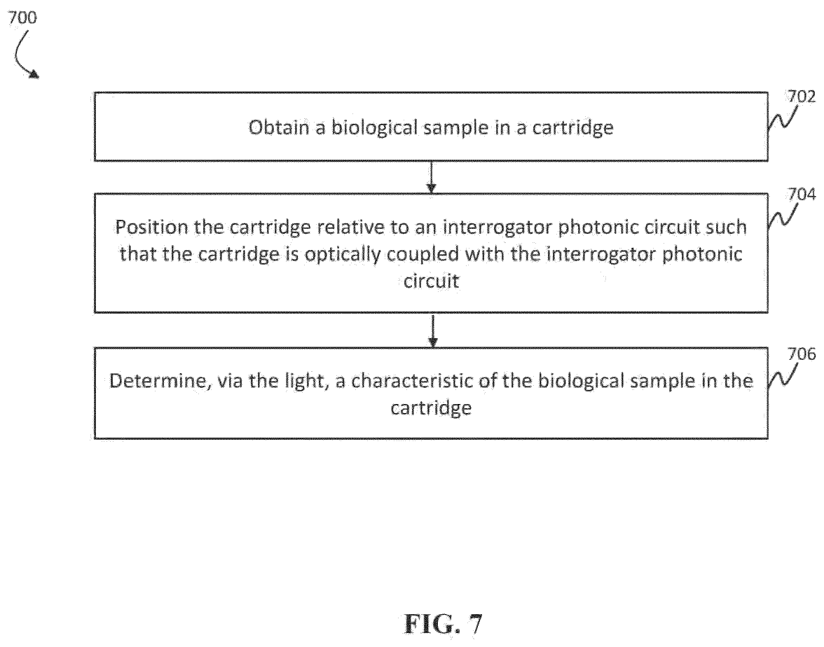

FIG. 7 illustrates a method 700 for biosensing utilizing the integrated photonic system 600. In step 702, a biological sample is obtained in the cartridge 604. In step 704, to sense a characteristic of the biological sample (e.g., perform a test), a cartridge 604 is positioned onto the stage 610. The cartridge 604 can be positioned such that it is optically coupled with the interrogator 602. Note that the biological sample may be loaded into the cartridge 604 before or after the cartridge is placed 604 onto the stage 610. In step 706, the light source 606 can be activated to determine a characteristic of the biological sample in the cartridge 604, as described in further detail below.

In some embodiments, system 600 can include an alignment module 612 configured to facilitate alignment between a light path of the interrogator 602 and a light path of the cartridge 604 (e.g., a light path of the sensor chiplet). The alignment module 612 may be physically adjacent to the interrogator 602 or to the cartridge 604.

The cartridge 604 may be positioned such that a light path of the cartridge 604 is aligned with a light path of the interrogator 602. For example, the cartridge 604 is aligned to the alignment module 612 for horizontal optical coupling (e.g., in the plane of the subchip or chiplet). In some embodiments, the alignment may be active, e.g., by monitoring an optical response. In some embodiments, the alignment may be passive using mechanical alignment features of the cartridge 604, sensor chiplet, and/or stage 610. After this initial alignment, adjustments may be made to the optics in the alignment module 612 to increase coupling efficiency. For example, desirable coupling efficiency between the cartridge 604 and the interrogator 602 may be at least 10%, at least 20% at least 50%, at least 60%, at least 70%, at least 80%, at least 90%, at least 95%, etc.

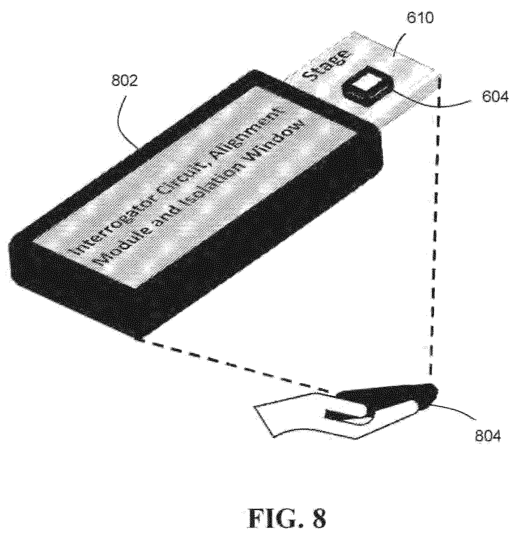

Note that the interrogator 602 and other components can be reused to analyze biological samples sensed via the cartridge 604. The cartridge 604 may be disposable after use by a single biological sample. In some embodiments, to prevent contamination, the cartridge 604 and/or stage 610 may be physically separated from the alignment module 612 and interrogator 602 by a transparent window 614 (also referred to as an “isolation window”) to ensure no physical cross contamination. Referring to FIG. 8, In some embodiments, the interrogator-side components 802 may be packaged together in a single housing and referred to as an “optical reader.” The optical reader 802 can include the interrogator circuit 602, alignment module 612, and/or isolation window 614. The optical reader 802 and the cartridge-side components (e.g., cartridge 604 and/or 610) may be configured into a handheld apparatus 804, as described in further detail below. Due to horizontal optical coupling, compact footprint, and disposability of the cartridge 604, the arrangement described above enables an inexpensive, hand-held point-of-care device.

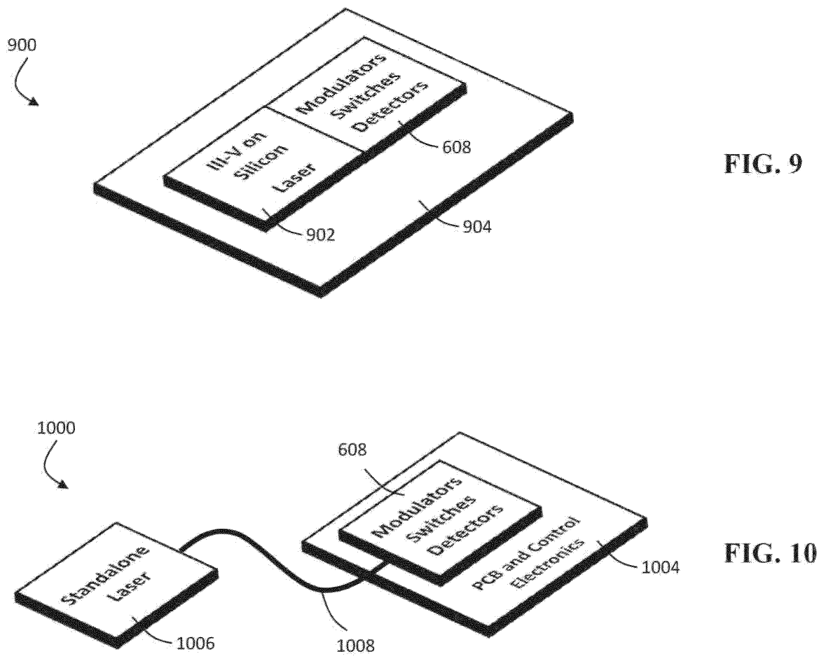

FIGS. 9-10 illustrate embodiments of interrogator 602. In example interrogator 900, the light source 902 (e.g., laser of a III-V on silicon type chip) is edge-coupled to the control circuit 608. The light source 902 and control circuit 608 can be assembled on a PCB 904. This configuration may be referred to as “on-chip laser.” In example interrogator 1000, the light source 1006 is a standalone laser connected to the control circuit 608 by an optical fiber 1008. This configuration may be referred to as “off-chip laser.”

Example alignment modules 612 may be assemblies that include photonic integrated circuits with edge couplers, grating couplers, micro-electromechanical system (MEMS) mirrors, phased arrays, lenses, and/or fiber arrays. The alignment module 612 can facilitate the optical coupling between the interrogator 602 and the sensor chiplet of the cartridge 604. Once the cartridge 604 is mechanically aligned on the stage 610, the interrogator 602 searches for an optical response from alignment optics on the sensor chiplet (of the cartridge 604) and/or the cartridge 604. The interface of the alignment module 612 can send a signal to determine alignment. The same interface, through the same or different ports, can receive a signal back.

The interface can include an array of edge couplers, a 2D fiber array, a 2D phased array of grating couplers, etc.

In some embodiments, active switches on the alignment module 612 are tuned to send the signal, e.g., through different output couplers or fibers and/or at a different angle from the phased array. Depending on the captured response, the switches may be tuned to optimize (e.g., increase) coupling. In some embodiments, in place of a phased array, MEMS mirrors may be employed to beam-steer. The stage 610 may have active mechanical alignment capability via micro-actuators. The micro-actuators may also be driven using feedback from the alignment module 602. In order to improve coupling, a ball lens or other lens may be employed to focus the light exchanged between the alignment module 612 and the sensor chiplet or cartridge 604. In some embodiments, this lens may also be moved using micro-actuators to improve optical alignment.

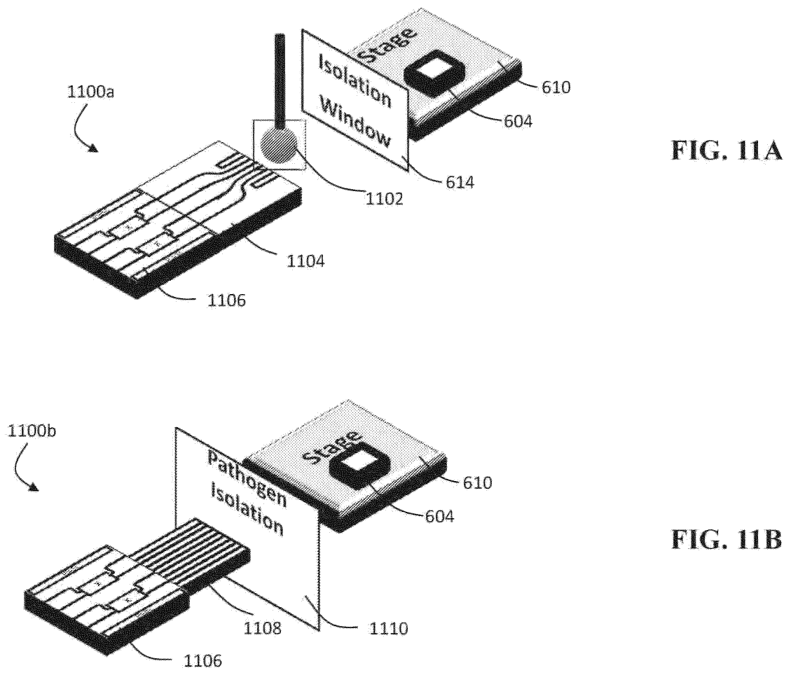

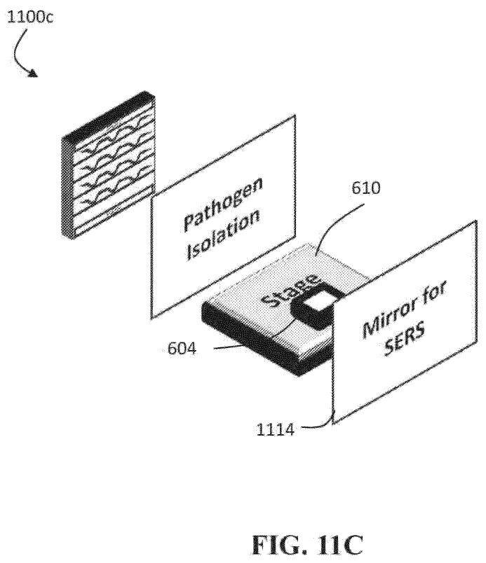

FIGS. 11A-11C illustrate embodiments of an alignment module. FIG. 11A illustrates an alignment module 1100a including one or more lenses configured to focus light between the interrogator 602 and the cartridge 604. For example, the lens can be a ball lens 1102 that can be adjusted in one or more axes (e.g., by an actuator). The alignment module 1100a may include an edge coupler array 1104 edge-coupled with a switch network 1106. FIG. 11B illustrates an alignment module 1100b including a switch network 1106 connected to a fiber array 1108. Note that some embodiments may include a pathogen isolation barrier 1110. This barrier can be used to isolate the cartridge 604 and/or stage 610 from the interrogator 602 and/or alignment module 612 (e.g., to avoid contamination if infectious pathogens are present, to allow for sterilization or cleaning if needed, etc.). The barrier 1110 can be transparent in the relevant wavelength range (e.g., UV-visible or infrared). FIG. 11C illustrates an alignment module 1100c that includes a phased array beam-steering chip or a MEMS beam-steering chip 604. This embodiment may include a mirror 1114 for surface-enhanced Raman scattering (SERS).

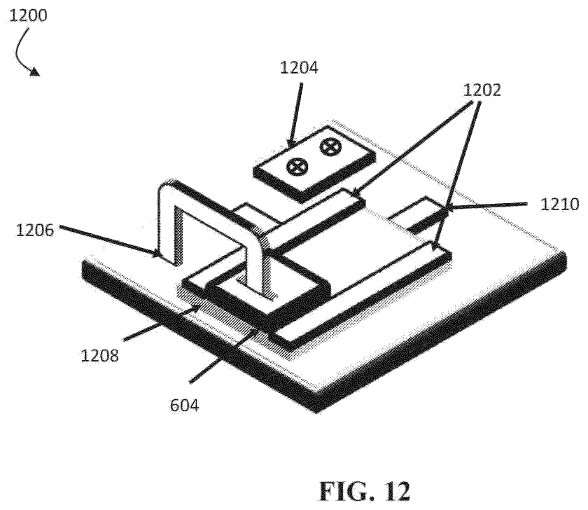

FIG. 12 illustrates an embodiment of a stage 1200, which enables the efficient and easy replacement and/or alignment of the cartridge 604. Passive alignment features 1202 on the stage 1200 can be used to precisely align the cartridge 604. In some embodiments, active micro actuators are used to improve mechanical alignment. In some embodiments, a piezoelectric device 1210 may be used for mechanical alignment. Alignment that is not accomplished by the stage 1200 may be compensated for electro-optically in the alignment module 612. For example, the alignment module 612 can be configured to ensure that light passes from the interrogator 602 to the sensor chiplet and then return to be detected (by the interrogator 602). In some embodiments, the sensor chiplet includes and/or is coupled to a microfluidic cell. Further, the stage 1200 may include a microfluidic cell that accepts test chiplets, or connections for the microfluidic cell that may be included on the sensor chiplet. The stage 1200 may include a pump 1204 that can drive flow in the microfluidic cell. The stage 1200 may have a source of varying magnetic fields to power magnetic stirring (e.g., via magnetic mixer 1206) in the microfluidic cell. The stage 1200 may be adapted to perform PCR and other reactions requiring temperature control (e.g., by a controller 1208) via temperature cycling provided by built-in thermoelectric heaters and/or coolers. Electrical connections may be built into the stage 1200 to power heaters or other electronics on the cartridge 604 or sensor chip (via the cartridge 604). The stage 1200 may be configured to accept multiple cartridges 604. The stage 1200 may be configured to discard a cartridge 604 after use and, In some embodiments, replace it with another one automatically (e.g., via a robotic arm, as described further herein).

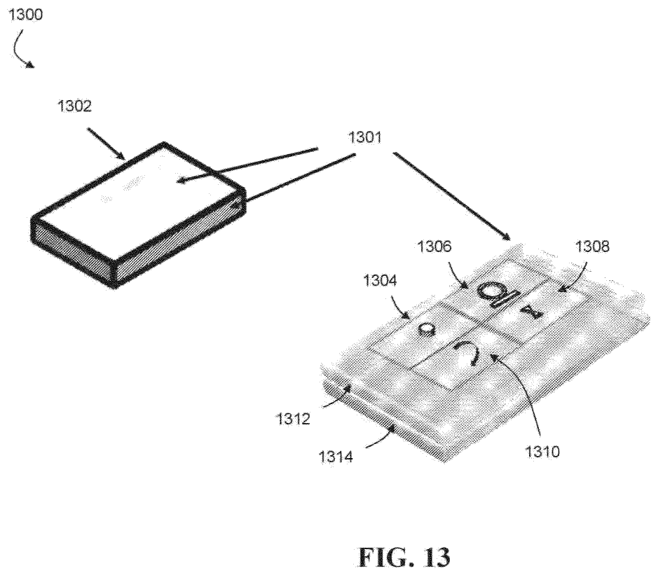

FIG. 13 illustrates an example cartridge 1300, which may be an assembly including a sensor chiplet and one or more microfluidic cells. In some embodiments, the housing of the cartridge 1300 can be configured to house any sensor chiplet and, optionally, one or more microfluidic cells with compatible features and/or sizes. The cartridge 1300 may be configured to house a plurality of sensor chiplets and, optionally, microfluidic cells 1301. For example, the housing 1302 can have mechanical alignment features so as to align with the interrogator 602 and/or stage 610. There may be multiple configurations of cartridges 1300, in which each configuration may support different types of sensor chiplets and/or microfluidic cells. The cartridge 1300 may have connection ports for electronic connections from the stage 610. An electrical connection to cartridge 1300 may be made for electrochemical sensing simultaneously with optical connection. The cartridge 1300 may have microfluidic input and/or output ports.

The example cartridge 1300 includes a microfluidic cell, a one-way analyte input 1304, a photonic sensor array 1306, reagents 1308, and a mixing device 1310 (e.g., a magnetic input or output, pump input or output, etc.). The cartridge 1300 may be made of, at least in part, silicon, silicon nitride, porous silicon, thin film gold on Si02, or other chip materials. The cartridge 1300 may be adapted to one of many labeled and label-free biosensing tests via a microfluidic cell 1312 on top of the sensing surface 1314.

As illustrated in FIG. 13, the microfluidic cell 1312 may be directly on top of the sensor chiplet 1314. In other embodiments, the microfluidic cell 1312 may be integrated into the cartridge and receive the sensor chiplet 1314. The microfluidic cell 1312 can be used to receive the analyte, which may be delivered through a sealable one-way input 1304 to ensure pathogen isolation, may deliver reagents 1308 to the sensing components on the sensor chiplet 4515, and/or may mix or flow (e.g., via mixing device 1310) the analyte to ensure sufficient and fast interaction between the analyte and the sensor chiplet surface 1314. An input and output port may be included to receive reagents 1308 or for pumping using an external pump on the stage 610. The microfluidic cell 1312 may include a paper or other component to create flow using capillary forces. The microfluidic cell 1312 may apply heat by light (e.g., via plasmonic antennas) or micro-electric heaters (e.g., on the sensor chiplet 1314). The microfluidic cell 1312 may generate vortex mixing or include magnetic micro-mixing components (e.g., those made by Redbud Labs, Inc. of Research Triangle Park, North Carolina, USA). In some embodiments, the microfluidic cell 1312 is fabricated in many copies onto an entire wafer of sensor chiplets 1314, and then diced along with the underlying wafer. This enables wafer scale fabrication of the sensor chiplet 1314 and microfluidic cell 1312 together.

### 2.1 Mechanical and User Interface Implementations

In the following, implementations of the integrated photonic biosensing systems are provided. Such implementations may include portable or tabletop systems and may be referred to as the “Pandemic Response Optical Biosensor Engine,” “PROBE,” or “photonic biosensing platform.” For example, these photonics-based sensing systems and methods can be used as part of a rapid, point-of-care medical diagnostics platform.

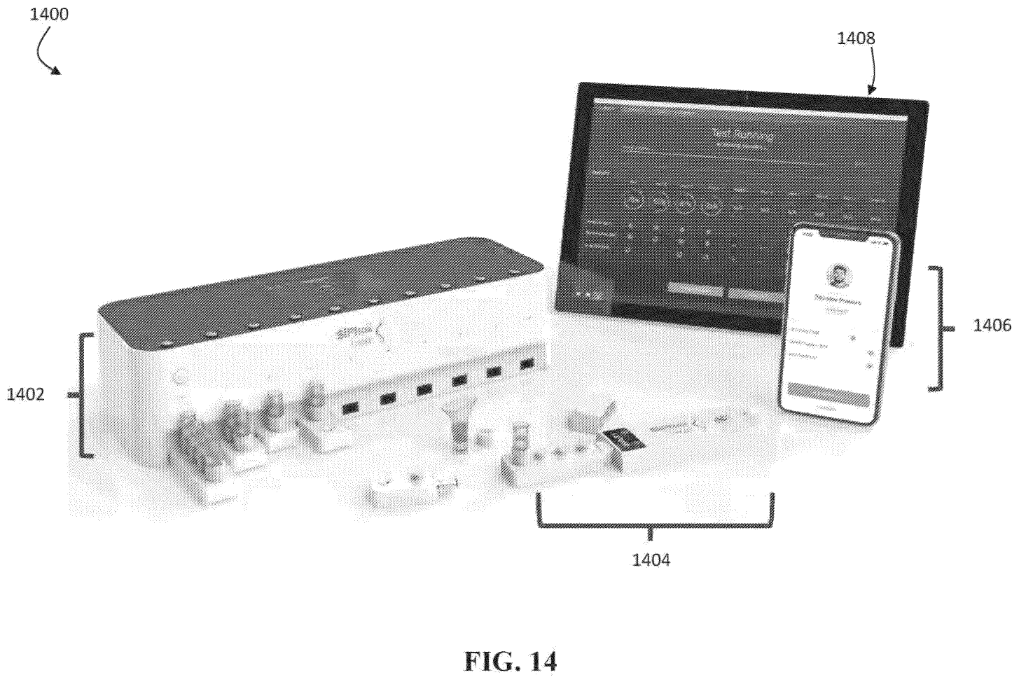

FIG. 14 illustrates various components associated with the photonic biosensing platform. As described in further detail below, the example platform 1400 can include tabletop apparatus 1402, handheld probe apparatus 1404, and display and related software 1406 to monitor and communicate real-time testing results. In some embodiments, the platform 1400 may include an additional interface 1408 for presenting the same or different information as the display 1406.

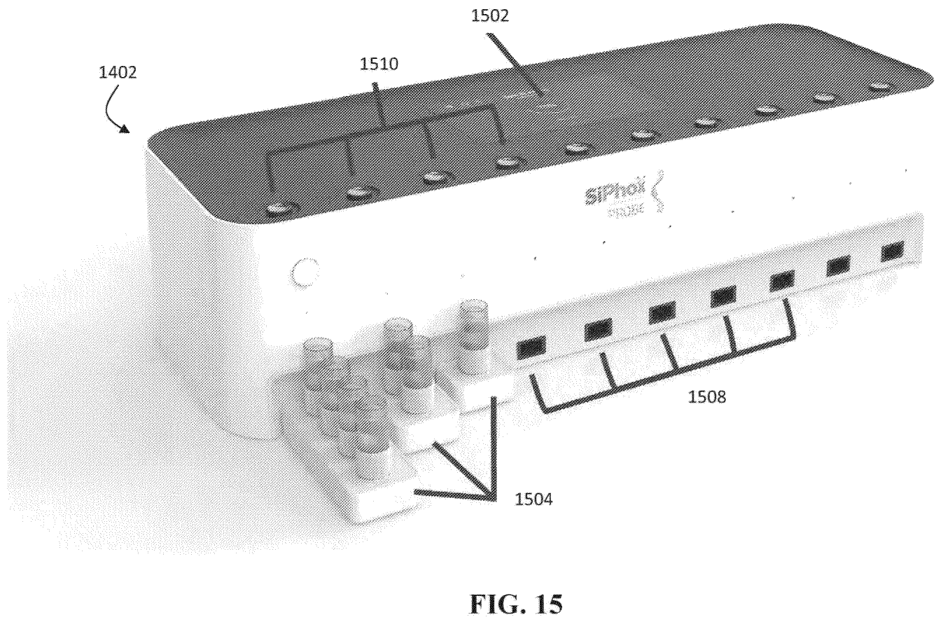

FIG. 15 illustrates the example tabletop apparatus 1402, including display 1502, disposable test cartridges 1504, apparatus input ports 1508, and buttons 1510. The example display 1502 can be configured to communicate testing results in real-time or near real time to a user of the platform. The disposable cartridges 1504 can be used to test biological samples including, e.g., saliva, blood, urine, mucus, nasal swab sample, etc. The input ports 1508 can be configured to connect and align cartridges 1504 to the tabletop apparatus 1402. The tabletop apparatus 1402 is configured to interrogate the cartridges 1504 using the methods described herein. For example, a user can initiate the testing in a particular cartridge or set of cartridges 1504 by pushing the button 1510 associated with the input port. Note that the apparatus 1402 can be configured to test multiple samples (e.g., in respective cartridges 1504) in parallel.

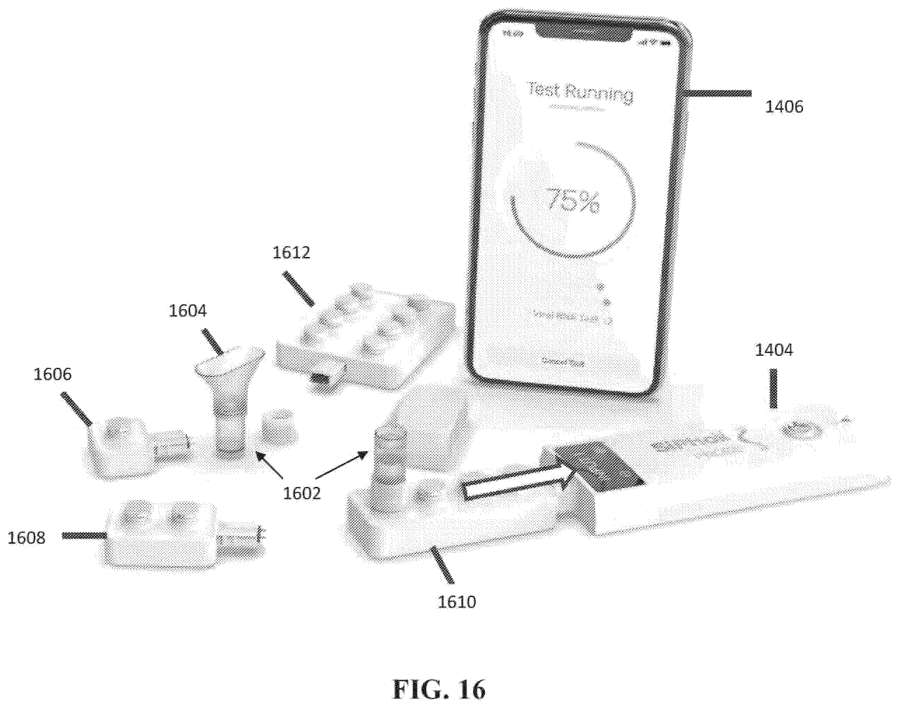

FIG. 16 illustrates the example portable apparatus 1404, and related components, and the display and related software 1406. The portable apparatus 1404 can be a handheld device configured to test a single cartridge 1504 at a time. In some embodiments, the apparatus 1404 can be configured to test more than one cartridge 1504 at a time. As illustrated the portable apparatus 1404 has one input port for cartridge 1504. Each cartridge 1504 can hold one or more tubes 1602 to hold the biological sample. For example, cartridge 1606 can hold a single tube 1602, cartridge 1608 can hold two tubes 1602, cartridge 1610 can hold four tubes 1602, and cartridge 1612 can hold eight tubes 1602. One or more tubes 1602 of biological sample can be in contact with a sensor chiplet and/or a microfluidic cell, as described above. In some embodiments, a collection funnel 1604 can be fitted to the cartridge 1504 to facilitate collecting of the biological sample. The apparatus 1404 can include a communication module (e.g., via Bluetooth, Wi-Fi, RFC, radio, etc.) configured to communicate with the mobile device 1406. An application on the mobile device 1406 can be configured to process information from the apparatus 1404 to monitor and/or display the test status and/or results.

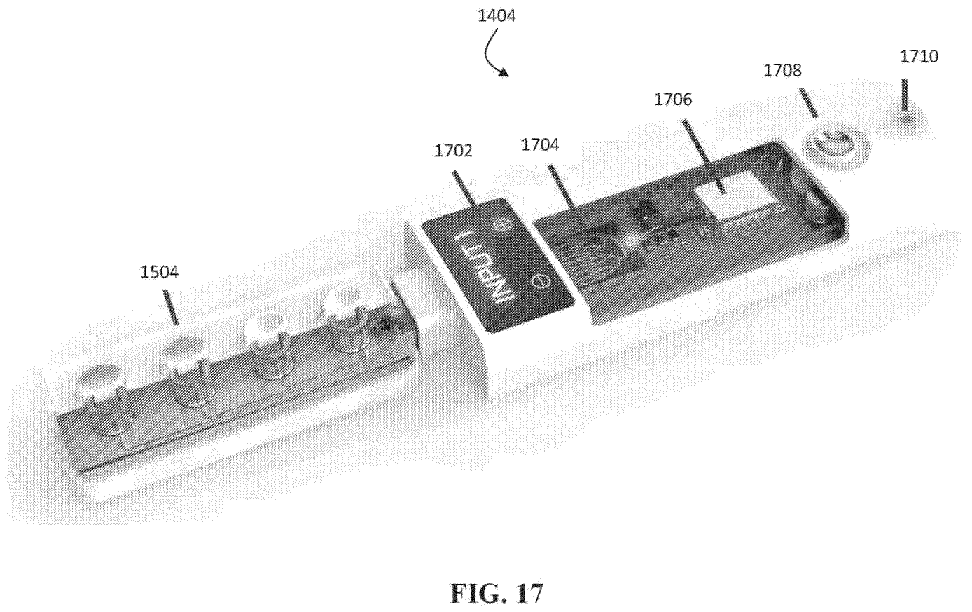

FIG. 17 illustrates the example handheld apparatus 1404 optically coupled to cartridge 1504. The apparatus 1404 includes a display 1702, one or more waveguides 1704, a light source 1706, a heating pad 1708, and a status indicator 1710. The display 1702 can be configured to confirm proper insertion (e.g., including alignment) of the test cartridge 1504 into the apparatus 1404. For example, the display 1702 can indicate with a light (e.g., LED), color, text, etc. whether the cartridge 1504 is properly fitted. As described above, the light source 1706 provides light to the waveguides 1704 to be used for sensing (e.g., by the sensor chiplet) at the test cartridge 1504.

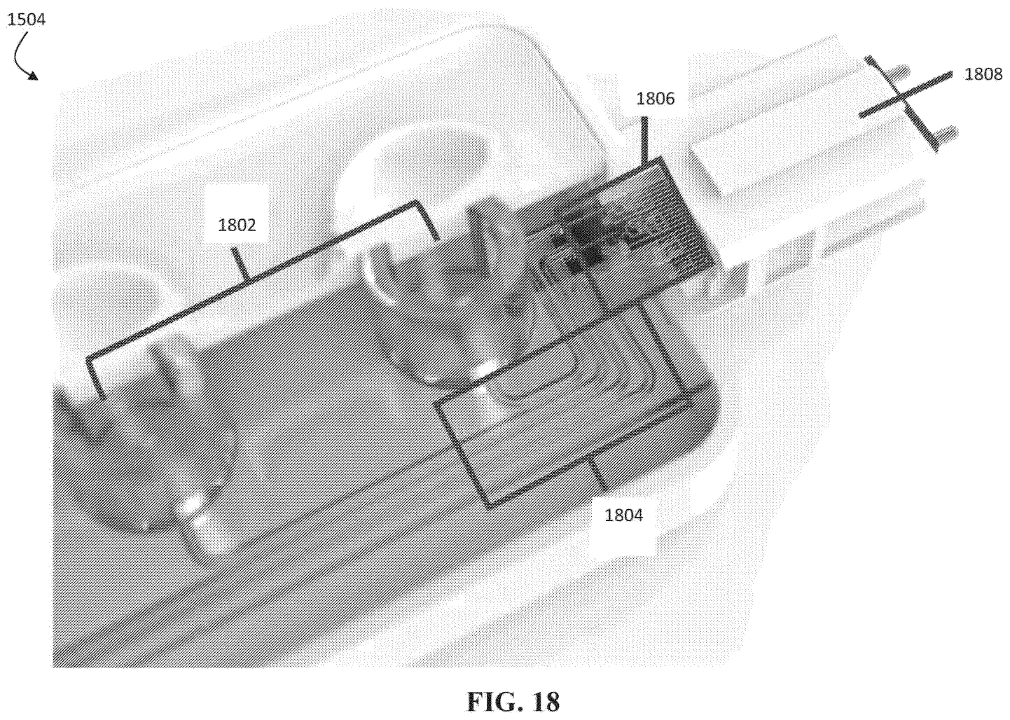

FIG. 18 illustrates a close-up view of example cartridge 1504 configured to be inserted into the tabletop apparatus 1402 or handheld apparatus 1404. In some embodiments, the disposable test cartridge 1504 may include lyophilized CRISPR compounds (e.g., CAS 9, 12, 13, etc.) to facilitate detection. The test cartridge 1504 includes a reservoir 1802 for holding a test sample, one or more microfluidic channels 1804 that transport the test sample towards the active photonics-based sensing area, the sensing area 1806 where photonics-based biosensing is performed on samples, and a connector 1808 for mating and alignment with the interrogator apparatus (e.g., the tabletop 1402 or handheld apparatus 1404).

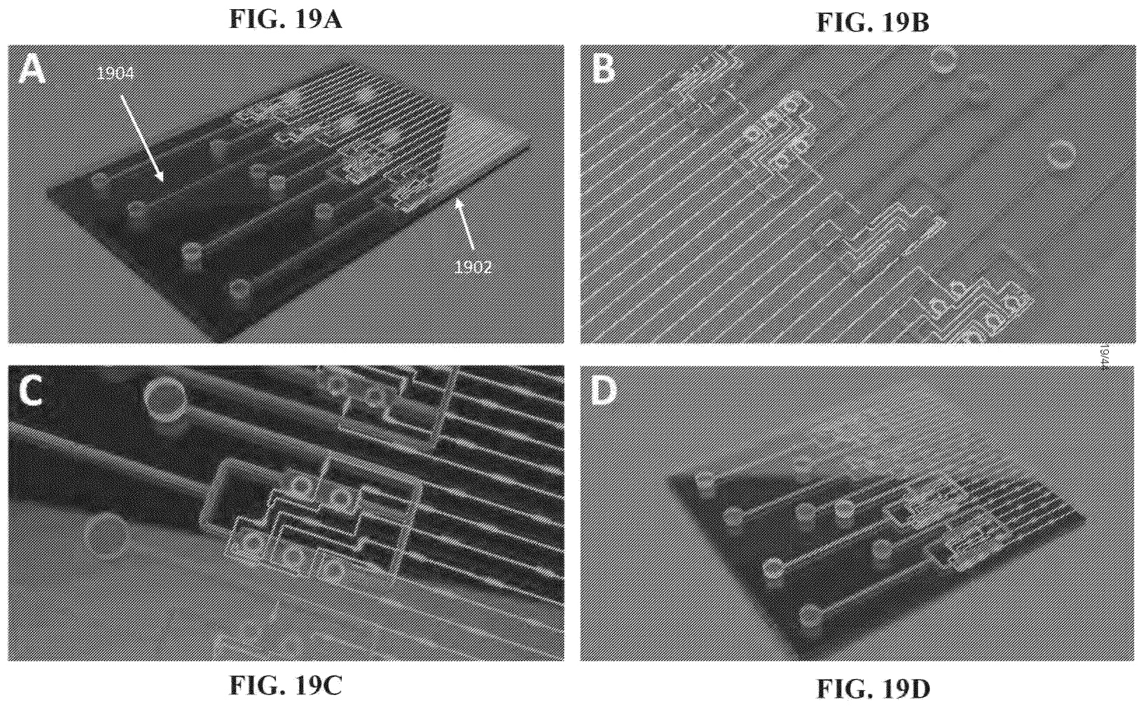

FIGS. 19A-19D illustrate four implementations of the biosensor chip 1902 with microfluidics 1904 that may be used within the test cartridge 1504. Each chip can have multiple sensing channels and can accept one or more types of reagents, e.g., saliva and blood.

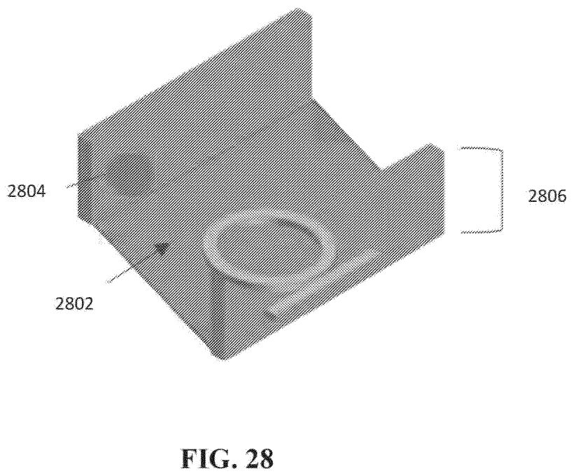

In various embodiments, the microfluidics channels used to transport the analyte in the sensing systems and methods described herein can be configured to facilitate detection of the sensing target, biological marker, pathogen of interest, etc. For example, the analyte including at least one of the reporter probes, sensing targets, biological markers, pathogens, etc. may flow perpendicular to the waveguide in a microfluidic channel to maximize interactions associated with the sensing protocols outlined above. Forcing the analyte past the waveguide may increase the probability of any number of the described interactions in the sensing schemes described above (e.g., binding, cleaving, etc.). FIG. 28 illustrates an example microfluidic channel 2802 that transports analyte to the waveguide (e.g., of the sensing area, as illustrated in examples of FIGS. 19A-19D). In some embodiments, an amplification agent (e.g., sensing amplifiers) 2804 may be applied to the channel 2802 to improve sensitivity to a particular characteristic of the biological sample. In some embodiments, the channel height 2806 may be manipulated to improve sensitivity. For example, the microfluidic channel height 2806 may be optimized to promote interaction between the analyte and the waveguide. In some embodiments, the microfluidic channels may be made using oxide etching of the cladding oxide on silicon photonic chips and sealing the channel overhead (e.g., via flat silicon bonded to silicon in a later step). Varying the thickness of oxide may control the resulting microfluidic channel height 2806. Additionally or alternatively, deep trenches etched in the silicon chip may be used as additional channels or fluid reservoirs to store analyte prior to interaction with the waveguide or after it flows past the waveguide.

### 22 Biosensing Methods

Methods and systems related to biosensing with a photonic waveguide on a sensing chip or fiber are described herein. The sensing chips or fibers may be made using silicon, silicon nitride, silicon dioxide or any other commonly used waveguide materials. In some embodiments, the methods/systems described herein include additional known amplification techniques.

In some embodiments, the sensor chiplet is adapted to perform label-based (“labeled”) and/or label-free biosensing tests. In some embodiments, the sensor chiplet performs biosensing via in-plane light propagation through waveguides. In some embodiments, the sensor chiplet performs biosensing via reflections (such as Surface Enhanced Plasmon Resonance) or other out-of-plane interactions.

In some embodiments, biosensing is performed on a surface in an electronic, optical, MEMS, or optoelectronic device. General sensing techniques include but are not limited to using a doped optical waveguide or electrodes near a waveguide to sense the optical change or resistance change, respectively, after a binding or cleavage event. In some embodiments, optical changes may be detected using surface plasmon resonances, Mach-Zehnder interferometers, spiral waveguides, Bragg gratings, and/or photonic crystals or magnetic dielectric mirrors. In some embodiments, the waveguide is configured to detect a signal based on wavelength dependence or a wavelength resonance. In some embodiments, the interferometer is an unbalanced Mach-Zehnder Interferometer.

In some embodiments, a microfluidic cell is placed on top of the sensing surface. Such a microfluidic cell can be used to control flow of reagents, sample, and other components to and from the sensor chiplet.

As described herein, integrated photonic sensors can be used to detect changes to biomolecules, e.g., due to binding or cleavage interactions, that are immobilized on or near a waveguide. The evanescent field emanating from the waveguide is used to sense a change in the biomolecule.

In some embodiments, optical changes may be detected using surface plasmon resonances, Mach-Zehnder interferometers, spiral waveguides, Bragg gratings, and/or photonic crystals or magnetic dielectric mirrors.

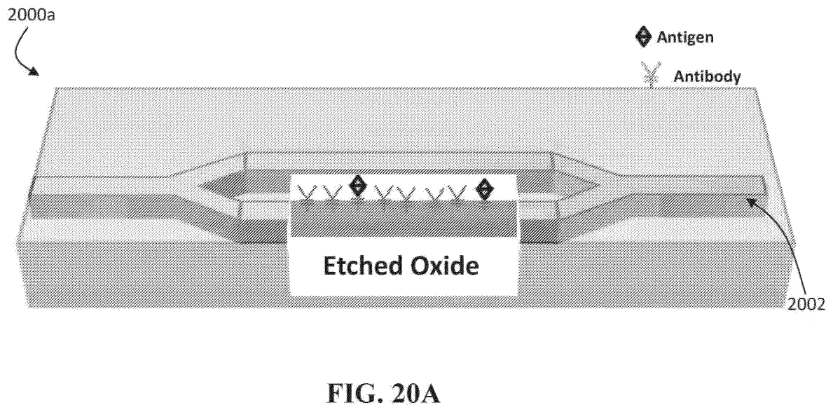

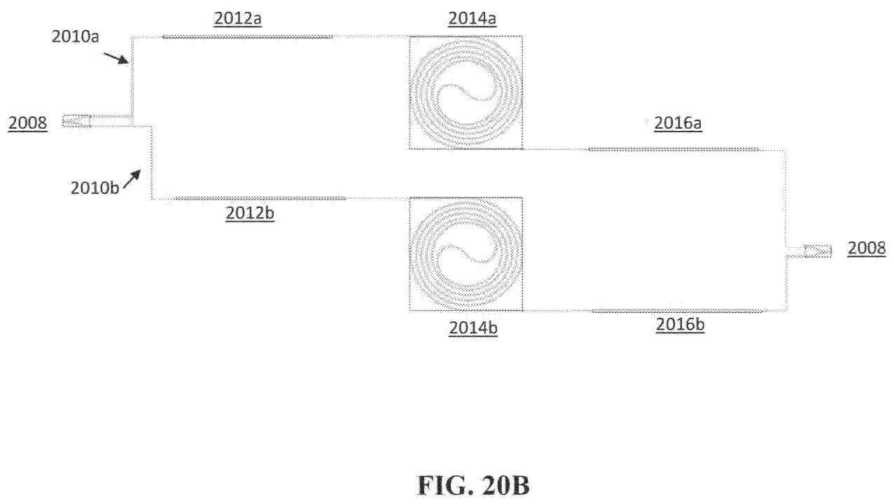

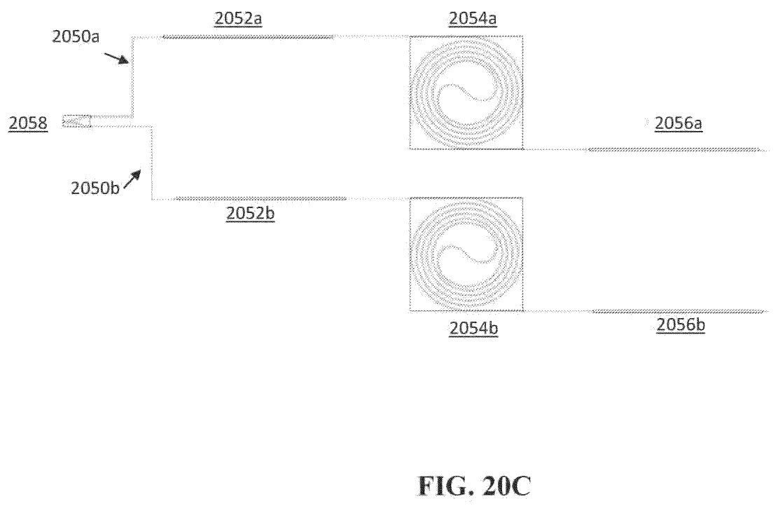

In FIG. 20A, the sensor chiplet 2000a (also referred to as an integrated photonic sensor) can include a waveguide 2002. At least one channel of the waveguide 2002 may include antibodies (e.g., may be coated with, bound to, or linked to the antibodies). These integrated photonic sensors rely on the binding of antigens from the analyte to antibodies that are immobilized on or near the waveguide 2002. The evanescent field emanating from the waveguide can be used to sense the refractive index change due to the presence of antigen after binding. If the waveguide is one arm of an interferometer (for example Mach-Zender or Michelson Interferometer), as shown in FIG. 20A, a phase change is introduced by the change in the effective refractive index experienced by the light passing through the waveguide, thus causing a change in intensity output from the interferometer.

FIG. 20B illustrates a Mach-Zender Interferometer (MZI)-type sensor. The sensor 2000c can include a Y-splitter 2008 in which a first (reference) channel 2010a includes a Bragg reflector 2012a, a spiral waveguide 2014a, and a Bragg reflector 2016a, and a second (sensing) channel 2010b includes a Bragg reflector 2012b, a spiral waveguide 2014b, and a Bragg reflector 2016b. In some embodiments, the spiral waveguide 2014a of the reference channel 2010a is not functionalized to sense the target analyte, and the spiral waveguide 2014b of the reference channel 2010b is functionalized to sense the target analyte. Thus, the refractive index of the sensing channel 2010b changes when the target analyte is present (relative to the refractive index of the reference channel 2010a), which causes the spectrum of the light propagating through the sensing channel 2010b to shift (relative to the spectrum of the light propagating through the reference channel 2010a). This shift can be detected, and the magnitude of the shift may indicate the concentration of the target analyte at the surface of the functionalized spiral waveguide 2014b.

FIG. 20C illustrates an absorption spectroscopy type sensor. The sensor can include a Y-splitter 2058 in which a reference channel 2050a includes a Bragg reflector 2052a, a spiral waveguide 2054a, and a Bragg reflector 2056a, and a sensing channel 2050b includes a Bragg reflector 2052b, a spiral waveguide 2054b, and a Bragg reflector 2056b. In some embodiments, the spiral waveguide 2054a of the reference channel 2050a is not functionalized to sense the target analyte, and the spiral waveguide 2054b of the reference channel 2050b is functionalized to sense the target analyte. Thus, certain wavelengths of light propagating through the spiral waveguide 2054b of the reference channel are absorbed when the target analyte is present. The difference in intensity of the light in the sensing channel and the light in the reference channel, after passing through the spiral waveguides and at the wavelengths absorbed by the target analyte (or label, or cleaved probe) may be detected, and this difference may indicate the concentration of the target analyte at the surface of the functionalized spiral waveguide 2054b.

In the examples of FIGS. 20B and 20C, spiral waveguides are shown. However, any waveguide of suitable length to produce a detectable change in the optical characteristics of the light propagating in the waveguide responsive to the concentration of the analyte at the surface of the waveguide may be used. Such a waveguide may be referred to herein as a “long waveguide.”

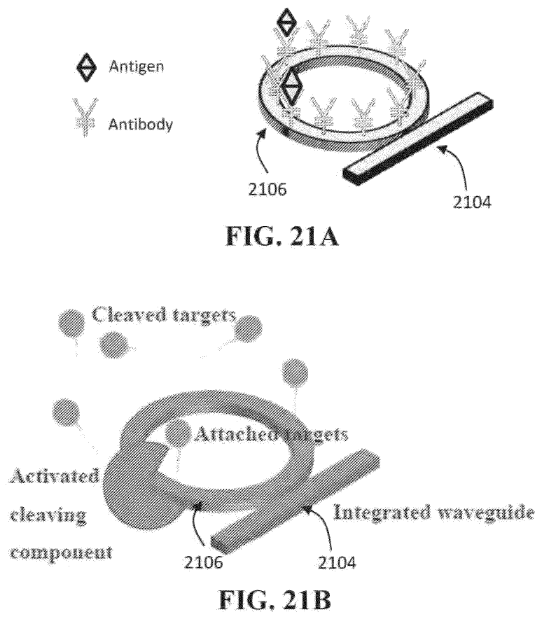

FIG. 21A illustrates an example method where an antigen binds to an antibody immobilized on a ring resonator. FIG. 21B illustrates an example method wherein a cleaving agent cleaves a reporter probe immobilized on a ring resonator. If the waveguide 2104 is part of a ring resonator 2106, the waveguide 2104 can detect a change in the resonance of the ring 2106, which will shift after a binding or cleavage reaction with one or more molecules. Alternatively, if the antigen or cleaved element is absorptive in wavelengths that are guided in a given integrated photonic waveguide, light intensity may simply be measured after passing through the waveguide.

### 2.2.1. Binding Assays

In some embodiments, an analyte can be detected through binding to a biomolecule immobilized on or near a waveguide. For example, binding of antigens to antibodies that are immobilized on or near a waveguide can be detected by an integrated photonic sensor. The evanescent field emanating from the waveguide is used to then sense a refractive index change due to the presence of antigen after binding.

In another embodiment, biosensing is performed by a biological marker (e.g. virus antigens, antibodies, etc.). The biological markers may be immobilized at or near the waveguide.

In some embodiments, whole pathogen detection is performed. The pathogen may be bound to a waveguide by functionalizing the waveguide with antibodies that capture the pathogen. However, because the refractive index of a virus, for example, is in the range of 1.4-1.5 and water is 1.33, it can be hard to detect a single viral particle. To increase the signal, an optically active component may be attached to the pathogen. In some embodiments, a plasmonic particle or other complex with strong optical properties may be attached to the pathogen by functionalizing the nanoparticle with antibodies for the pathogen. The pathogen may be bound to a waveguide by functionalizing the waveguide with antibodies that capture the pathogen.

In some embodiments, RNA/DNA is first functionalized with a reporter probe, then it may bind to conjugate DNA/RNA attached to the waveguide. The reporter probe may have a sequence that precisely binds the DNA/RNA (single strand). When the reporter probe is away from the waveguide, the binding site is therefore closed off. When the reporter probe connects to the sensing target (e.g. viral DNA) it unfolds, and the binding site is revealed.

The biological markers may be in solution and bind to the waveguide in any number of ways. The waveguide may then detect the refractive index change due to the presence of the biological marker at or near the waveguide. Alternatively, if the biological marker is optically active in the region at which the waveguide operates, the light intensity may simply be measured after passing through the waveguide.

### 2.2.2. Cleavage Assays

In some embodiments, a component of a sample can be detected by directly or indirectly resulting in a cleavage reaction which is detected by the sensor chiplet. FIG. 21B illustrates an example process wherein the cleaving agent cleaves a reporter probe from a waveguide.

In one example, a waveguide (e.g. associated with a ring resonator) is functionalized to immobilize reporter probes (e.g. RNA strands). Next, a cleaving component (e.g. a CRISPR enzyme) that may interact with the reporter probes and a sensing target of interest may be combined with the analyte carrying the sensing target. Herein, the use of a sensing target is intended to include any biological marker. This includes but is not limited to RNA, DNA, a molecule, an enzyme, an antigen, an antibody, a pathogen, etc.

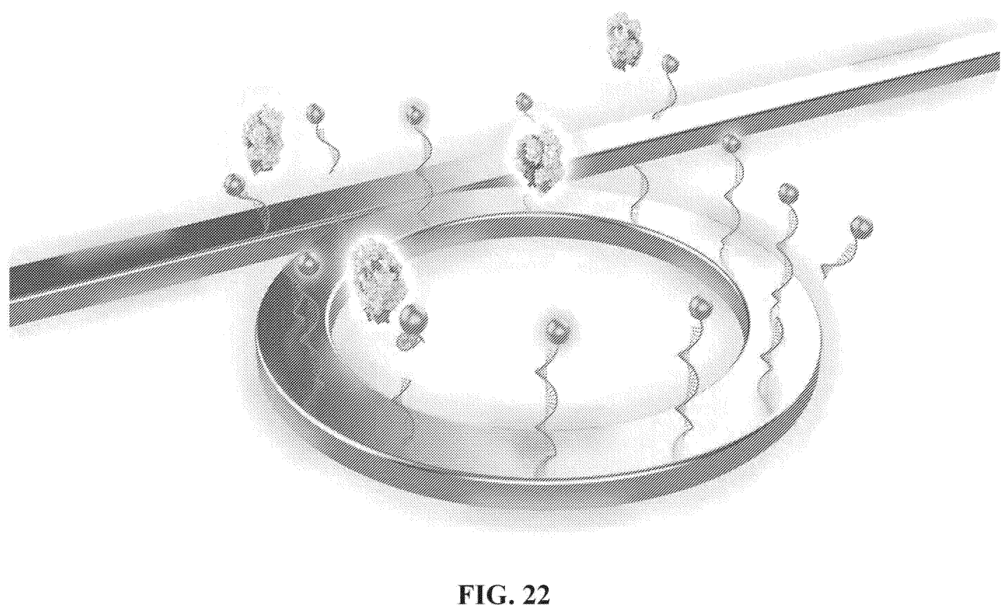

FIG. 22 illustrates one possible testing mechanism used by the PROBE apparatus; it utilizes A—waveguide, B—ring resonator, C—functionalized nanoparticles (e.g. reporter probe with optically active component), and D—sensing agents capable of cleaving the nanoparticles from the ring resonator. In one example, a waveguide (e.g. associated with a ring resonator) may be functionalized to immobilize reporter probes (e.g. RNA strands). These reporter probes may be linked to an optically active component (e.g. plasmonic nanoparticle, quantum dot, molecule, etc.) to enhance their optical effect on the waveguide and/or for downstream detection. Next, a sensing agent or cleaving component (e.g. a CRISPR enzyme) that may interact with the reporter probes and a sensing target of interest (e.g. virus RNA/DNA) may be combined with analyte carrying the sensing target (e.g. viral RNA from patient sample introduced into test cartridge). In some embodiments, the sensing agents are activated to cleave the functionalized nanoparticles only if they encounter biological material associated with a positive test result (e.g. viral RNA). The cleaving component may be activated, thereby indiscriminately cleaving the functionalized nanoparticles.

In some embodiments, if the reporter probes attached to the waveguide are removed, an optical change in the system may be detected in various ways. In one example, cleavage of the probes from the waveguide may result in a change in the refractive index of light guided within the waveguide; this change in refractive index may be detected using various spectroscopic techniques (e.g. resonance, interference, or absorption, etc.). Additionally or alternatively, the optically active component (e.g. plasmonic nanoparticle, quantum dot, molecule, etc.) attached to the reporter probes may be cleaved along with the reporter probes. The presence of these cleaved optically active components may be detected downstream from the waveguide using various techniques. Other known techniques for facilitating interactions between the waveguide and sensing targets, reporter probes, biological markers, pathogen, etc. (e.g. toehold switch) may be implemented in addition to or as an alternative to the described techniques.

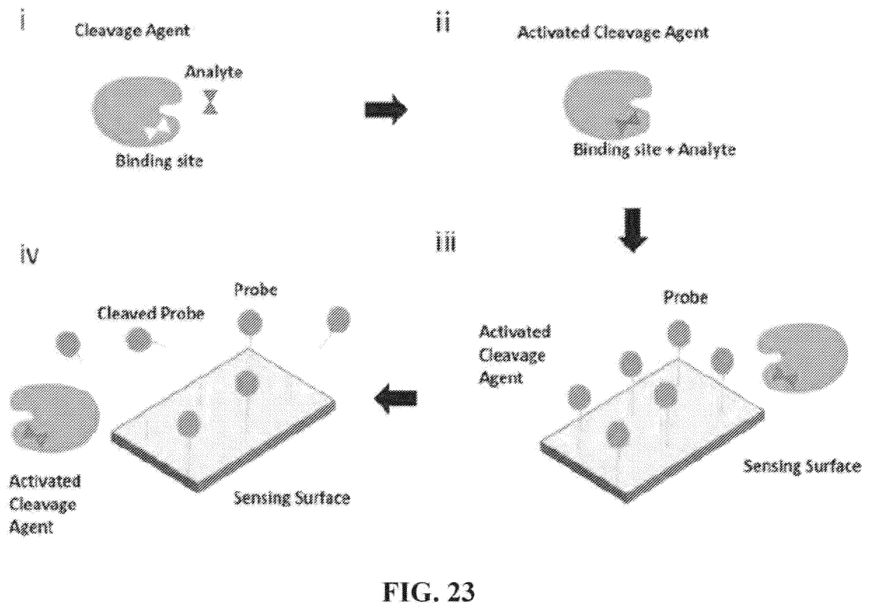

In some embodiments, as illustrated in FIG. 23, the cleaving component is designed to be activated only when it detects the sensing target of interest. Once the cleaving component is activated, it cleaves probes from the sensing surface, leading to a detectable signal (via resonance, absorbance, interference resistance changes or other detectable changes near the sensing surface).

In some embodiments, the cleaving component binds to the sensing target of interest. The cleaving component may be activated, thereby indiscriminately cleaving both the sensing target and immobilizer probes.

Various cleaving components (e.g. CRISPR enzymes activated by target RNA, or other enzymes activated by an analyte of interest) may cleave the reporter probes, removing them from the surface, when an analyte of interest binds to or is otherwise detected by the cleaving agents in solution.

In some embodiments, the probes are engineered to enhance the signal generated by cleavage events, which is distinct from other techniques where binding of analyte to the surface directly generates a signal. The readout may be done by immobilizing the probes on the surface of waveguides, such that the evanescent field interacts with the probes, but any surface method or any combination of surface methods (e.g. electrical and/or optical) may be used including transistors, nanopores, surface plasmon resonant thin films or particles, surfaces used for SERS spectroscopy, or electrical impedance (e.g., resistance) based sensors. In some embodiments, a high contrast cleavage detection system, where there is both a cleaving component that is either the analyte of interest or has a specific detection mechanism for the analyte of interest, and a solid-state probe that is functionalized onto a sensing surface (e.g. a waveguide, plasmonic thin film, etc.), is used.

In some embodiments, the cleavage event is caused by the analyte of interest or may be facilitated via a chemical in solution and/or from electromagnetic radiation (e.g. UV light). The method may be used directly to detect any effect that causes the probe removal; this includes light, heat, and other changes in the environment generally or locally that can cause the probe to detach. In a nonlimiting example, probes may contain UV cleavable linkages or heat-disassociated bonds. For sensing analytes in solution that are exposed to the surface, the cleavage event may be activated by a chemical or enzyme associated with the sensing target. In one non limiting example, the cleaving component may be an enzyme (e.g. CRISPR, a Toehold Switch RNA detection produced Enzyme or protein) that may cleave reporter probes (e.g. RNA strands) immobilized on the surface of an electronic, magnetic, MEMS, optical, or optoelectronic device. The cleaving component may be activated when it detects the sensing target of interest in solution, thereby cleaving the immobilized reporter probes.

In some embodiments, the immobilized reporter probes consist of an optically-active and/or conductive or magnetic component, which may facilitate detection of this cleavage event (e.g. via the optical signal or a change in resistance at an electrode described above). This cleavage may be sensed directly where it happens (e.g. by a change in response of a ring resonator/optical waveguide where the reporter probes were immobilized prior to cleavage) or the cleaved products (e.g. the cleaved reporter probes migrate away from the surface for detection elsewhere in the system). The cleaved products may migrate to and bind to a sensing surface via diffusion or mixing. In some embodiments, the cleaved product may be designed for strong binding affinity to the sensing surface (e.g. surface functionalized gold particles functionalized with biotin designed to bind to sensing surface functionalized with Streptavidin.)

This method may also be used to determine or sense activity or reaction kinetics associated with a biomolecule or enzyme even if the reaction is reversible. For example, if the surface is functionalized with an agent the biomolecule reacts with, a binding event associated with this reaction may be detected (e.g. via optical resonance shift etc.), and if the complex falls apart or is broken, this can be detected as a cleavage. The contrast can be increased by labeling the component that is added from solution using a gold nanoparticle or otherwise optically/magnetically/electrically active label that interacts strongly with the surface.

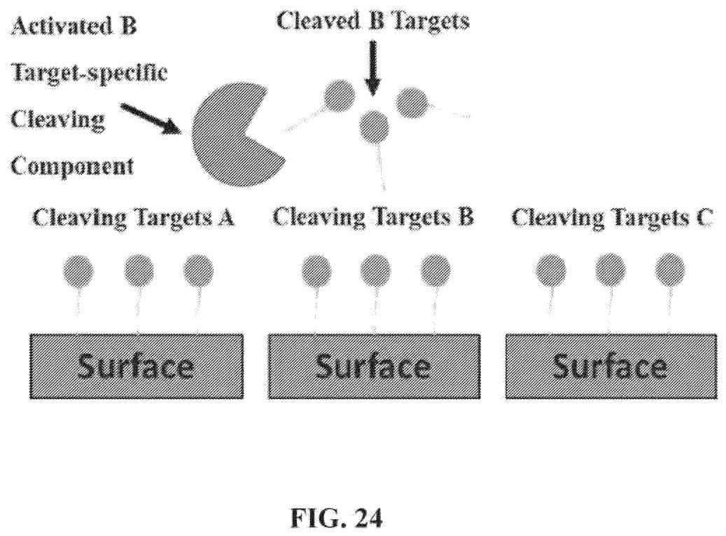

Additionally or alternatively, various enzymes may be attached to various surfaces and their activity may be monitored separately using the optical and/or electronic interactions described above. For example, an optical system may include multiple ring resonators where each ring resonator may be functionalized with a different enzyme (e.g. CRISPR CAS 12, CAS 13, etc.). These various cleaving components may be designed to be activated only when they are exposed to their specific sensing target of interest as shown in FIG. 23. Once activated, each cleaving component, tethered to the sensing surface, may cleave only cleave probes in its direct vicinity. This may lead to a change in the response (e.g. plasmon resonance optical readout or electronic transistor readout) of only the surface where the cleavage occurred (see FIG. 24). This may permit different regions or different surfaces to detect different analytes in the same sample without any interference and without the need for any microfluidic or other physical separation. In the nonlimiting example of RNA sensing with ring resonators, different resonators on a chip may be functionalized by a CRISPR enzyme carrying a different crRNA sequence, allowing each ring to become a sensor for that specific sequence when all the rings are exposed simultaneously to the same analyte. This can work with any version of the High Contrast Cleavage approach described.

Alternately, instead of attaching different enzymes or other cleaving agents with different target analytes to different sensing surfaces, the sample fluid may be split up into separate chambers, each containing a different cleaving agent (in a dried state or added via a different fluid input channel/port) with a different target analyte. This allows testing of the same sample for different analytes in parallel without interference. It may also be arranged in a serial fashion, where the sample flows first over a sensing surface where the microfluidic chamber contains the first cleaving agent, then flows into a chamber with the second cleaving agent, and so on (e.g. each chamber containing 1 or more sensing surfaces with cleavable probes). Using the two above described techniques (separate optical system with distinct enzyme, splitting sample fluid) may be useful for both redundant testing (e.g. for the same virus) by increasing sensitivity and/or specificity and multiplexing tests for multiple pathogens which may be advantageous for facile widespread testing.

### 2.2.3. Toehold Switch Assay

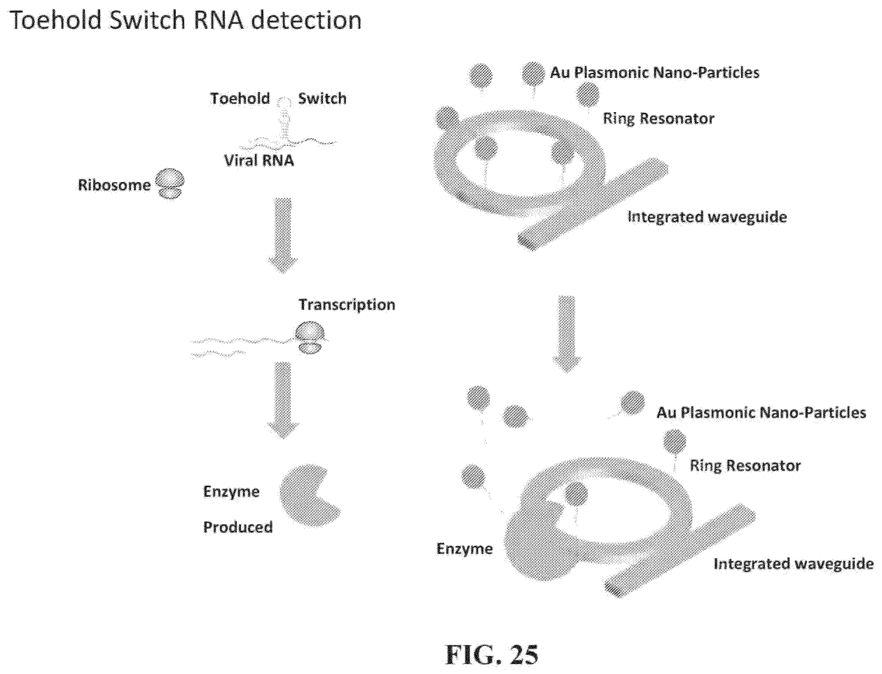

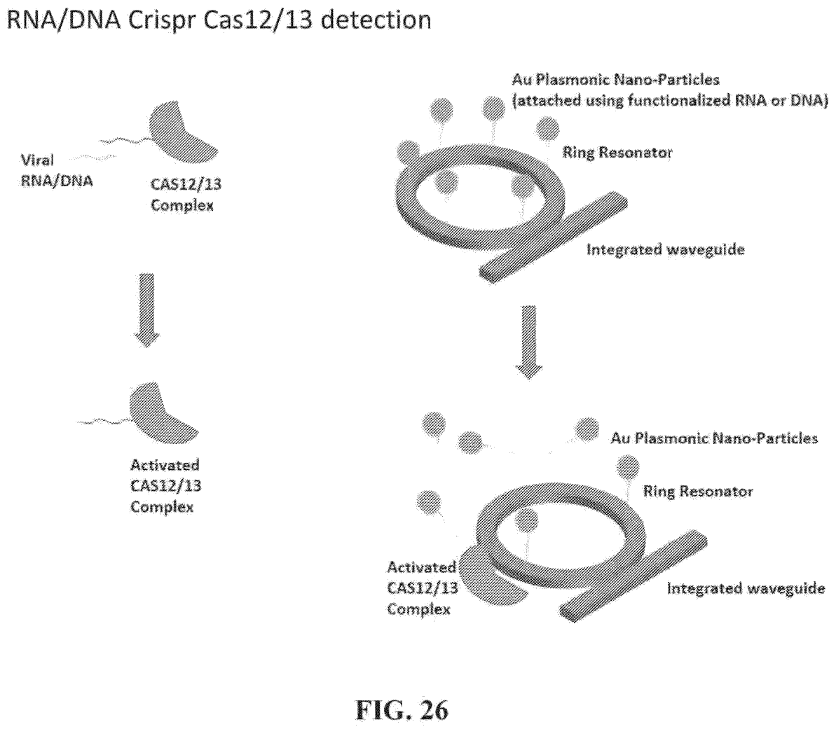

Shown in FIG. 25 and FIG. 26 are diagrams of methods developed for integrating diagnostic tests with waveguides and other integrated photonic components.

In FIG. 25, we illustrate a method for RNA detection using a toehold switch RNA approach based on what is demonstrated in Rapid, Low-Cost Detection of Zika Virus Using Programmable Biomolecular Components K Pardee et al. When the hairpin is opened by the target RNA binding to the toehold RNA, the ribosome binding site is exposed and the reporter protein sequence may be transcribed by a ribosome in solution. The reporter protein is chosen such that it may cleave the bonds that immobilize a plasmonic nanoparticle (or other complex with a strong optical response) from the waveguide surface. Again, the effect on the guided light within the waveguide may be detected using one of the methods described above (resonance, interference, or absorption).

In some embodiments, sensing target detection (e.g. RNA) may use a toehold switch RNA approach, as shown in FIG. 25. For example, the hairpin may be opened by the target RNA binding to the toehold RNA, thus the ribosome binding site may be exposed and the reporter protein sequence may be transcribed by a ribosome in solution. In some embodiments, this approach may generate an enzyme or other protein that may act as an input for the sensing approach. The reporter protein is chosen such that it may cleave the bonds that immobilize an optically active component from the waveguide surface. Thus, an effect on the guided light within the waveguide may be detected using one of the methods described above (e.g. resonance, interference, absorption, etc.)

### 2.2.4. CRISPR Assay

In one non-limiting example, the cleaving component is a CRISPR CAS-13 complex which cleaves all nearby RNA, including the RNA reporter probes immobilized on the waveguide.

In FIG. 26, we illustrate a method for DNA and RNA detection using CRISPR and a waveguide. A waveguide may be functionalized using standard methods with DNA or RNA strands. These strands may be linked to a plasmonic (e.g. gold) nanoparticle, quantum dot or another molecule to enhance their optical effect on the waveguide. A CRISPR enzyme such as CAS 12 (for DNA) or CAS 13 (for RNA) carrying the relevant sequence may be combined with analyte carrying the RNA or DNA of interest. When the CAS protein binds the RNA or DNA of interest it may be activated and used to cut multiple RNA/DNA strands nonspecifically. If the DNA/RNA strands attached to the waveguide are cut, the effect on the guided light within the waveguide can be detected using one of the methods described above (resonance, interference, or absorption). See Integrated Micropillar Polydimethylsiloxane Accurate CRISPR Detection (IMPACT) System for Rapid Viral DNA Sensing, Kenneth N. et al. for a similar approach.

In some CRISPR implementations, after a sensing target is identified, the cleaving component may cleave a cluster of enzymes connected with an RNA/DNA scaffold. These enzymes may become activated and may cleave probes from the photonic waveguide. In some embodiments, they may not be enzymes but instead some type of particle that binds to the waveguide. This binding changes the local refractive index. The binding site is therefore hidden when they are connected to the cluster. Thus, the binding site may only be opened when the particle is cleaved.

The processes above describe several possible sensing techniques using a photonic waveguide, as taught herein. These processes may be further performed with or without common techniques associated with biosensing (e.g. target amplification). Other known techniques for facilitating interactions between the waveguide and sensing targets, reporter probes, biological markers, pathogen, etc. (e.g. toehold switch) may be implemented in addition to or as an alternative to the described techniques.

### 2.2.5. Further Biosensing Embodiments

The target of interest may first be chemically amplified using techniques including but not limited to PCR or RT-LAMP or RPA.

In some embodiments, reverse transcriptase can be used to convert RNA to DNA. This may allow for DNA sensing systems like PCR or CRISPR CAS-12 to be implemented. For PCR, the sensing protocol may include emitting light into the analyte using vertical grating couplers or an evanescent field and then observing fluorescent response either using external or on-chip optics and photodetectors.

In another aspect of the present disclosure, a chemical reaction on the surface of an optical, electronic, magnetic, MEMS or optoelectronic device may be catalyzed. In one example, a chemical reaction at a waveguide may be catalyzed on a waveguide via an evanescent field associated with the waveguide. In some embodiments, the chemical reaction may be controlled via integrated photonics (e.g. by toggling the light on and off or switching between different input wavelengths) to activate chemical reactions selectivity (e.g. which reaction, where the reaction occurs, when the reaction occurs, etc.). Additionally or alternatively, reaction kinetics can be further controlled by controlling the intensity and/or wavelength using components such as ring resonators, optical switches, photonic crystals, Bragg gratings, LEDs, and lasers which are capable of introducing and controlling high-intensity light across a range of wavelengths. MEMS components may be fabricated either instead of or in complement to other components in order to control chemical reactions near the surface, induce mixing, induce polymer folding, induce strain in the surface or in polymers attached to the surface etc. In all cases, sensing may be done in parallel or serially as chemical reactions are occurring/being catalyzed/controlled.

In one implementation of High Contrast Cleavage Detection, an antibody, antigen or another analyte (which itself may be a complex of the target analyte and another molecule) may act as a bridge to combine two or more separate molecules into a cleaving agent which goes on to by an input to the sensing method as described above. Additionally, a cleavage agent may be designed with a blocked active site such that the blocking element can disassociate in the presence of the correct analyte or when some change is sensed (pH, temperature, etc.), again working as an input to the sensing method.

### 2.2.6. Optically Active Components

If the reporter probes attached to the waveguide are removed, an optical change in the system can be detected in various ways. In one example, cleaving the reporters from the waveguide may result in a change in the refractive index of light guided within the waveguide; this change in refractive index may be detected using various spectroscopic techniques (e.g. resonance, interference, or absorption, etc.). Additionally or alternatively, the optically active component (e.g. plasmonic nanoparticle, quantum dot, molecule, etc.) attached to the reporter probes may be cleaved along with the reporter probes. The presence of these cleaved optically active components may be detected downstream from the waveguide using various spectroscopic techniques (absorption, photoluminescence, fluorescence, etc.).

These reporter probes may be linked to an optically active component (e.g. plasmonic nanoparticle, quantum dot, molecule, etc.) to enhance their optical effect on the waveguide. Further, anything being captured by an antibody may be enhanced by attaching an optically active probe to it.

### 2.2.7. Reaction Kinetics

Several methods to increase the likelihood of interaction between the waveguide and analyte containing sensing targets, reporter probes, biological markers, pathogens, etc. are described. In one example, optical trapping (e.g. using strong electric field near waveguide or other photonic structure, similar to optical tweezers) to trap the sensing target at or near the waveguide.

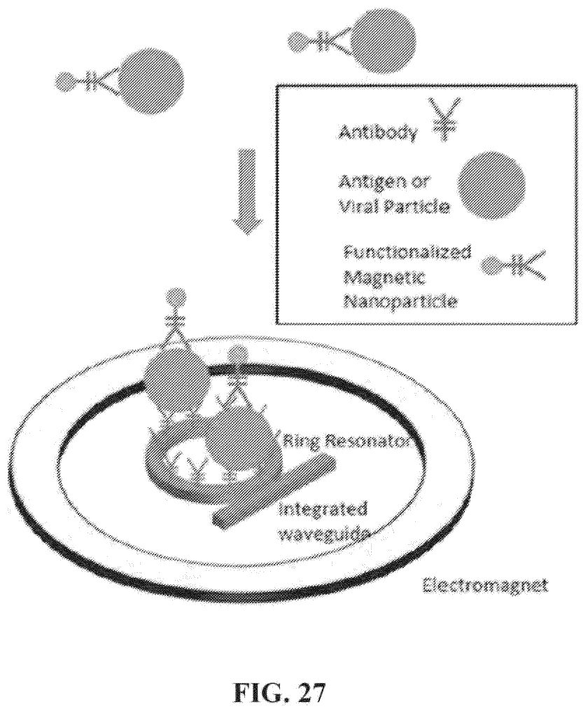

Additionally or alternatively, magnetic nanoparticles may be bound to the sensing targets, biological markers, or pathogens of interest. The sensing target, biological marker, or pathogen of interest may then be drawn to the sensing waveguide using a magnetic field applied externally or on the sensor. FIG. 27 further illustrates how attaching a magnetic particle to a sensing target may direct the sensing target to the waveguide via an applied magnetic field. By binding magnetic nanoparticles to the molecule or pathogen of interest, the complex may then be drawn to the sensing waveguide using a magnetic field, applied externally or via an electromagnet fabricated directly onto the sensor chiplet. This method may be combined with any diagnostic scheme, including those discussed above.

Additionally, one or more plasmonic antennas (e.g. a bowtie) may be fabricated on the chip such that local light-induced heating causes mixing via convection.

### 2.3 Integrated Photonic Assemblies for Biosensing

In various embodiments, the biosensing systems and methods can include multi-photonic-chiplet (MPC)-based point-of-care (POC) diagnostic biosensors for multiplexed, label-free biosensing. Current lab-on-a-chip optical biosensors transduce the nature and concentration of analyte of interest into an output signal by sensing the change in the refractive index of the optical waveguide. This detection mechanism has been achieved through a variety of optical phenomena based on the sensor configurations including surface plasmon resonance (SPR) sensors, surface-enhanced Raman scattering (SERS), photonic crystal-based gratings, micro-ring resonators, or unbalanced Mach-Zehnder interferometer (UMZI) structures. While decades of research in this area has drastically advanced the sensitivity and specificity of these commercially-available sensor technologies, realization of compact, inexpensive sensors for multiplexed sensing of biological analytes applicable to point-of-care diagnostics has been elusive. The present systems and methods aim to provide such benefits. In particular, the present disclosure discusses in part a compact multi-photonic-chiplet (MPC)-based point-of-care (POC) diagnostic biosensor that can provide an inexpensive, re-usable, and scalable solution for simultaneous sensing of an array of biological analytes with enhanced specificity and sensitivity of detection.

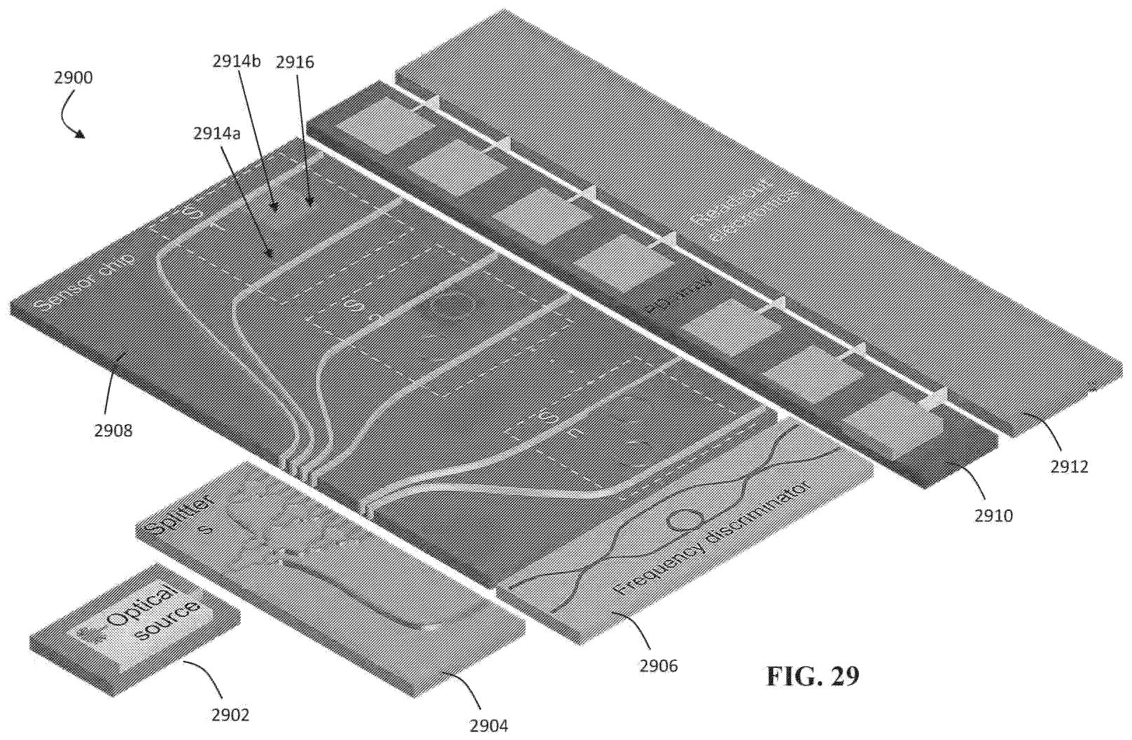

FIG. 29 illustrates an example implementation of the multi-photonic-chiplet (MPC)-based optical biosensor assembly 2900 for multiplexed sensing of analytes. This example assembly 2900 includes one or more multi-platform integrated opto-electronic chiplets. The chiplets can include an optical source 2902, a splitter network 2904, a frequency discriminator 2906, an array 2908 of sensing elements, a photo-diode array 2910, and read-out electronics 2912. The biosensor assembly 2900 may permit photonic chiplets having different elements of the sensing system (e.g., source, photodetectors (PD), and/or ring resonators) to be used in tandem. Each sensor element (labeled SI, S2 . . . Sn) of the sensor array 2908 may include two identical ring resonators 2914a, 2914b pumped by a tunable optical source. One of the resonators 2914b of the sensing element may be exposed to a biological analyte 2916, depicted as the shaded region around the ring, while the other resonators 2914a may be used as a reference. The optical source 2902 may be split across an array 2908 of sensing elements, enabling simultaneous or near simultaneous sensing of two or more analytes. This has the benefit of enabling each photonic component to be realized in the photonic platform of choice. For instance, this includes but is not limited to the currently foundry-friendly materials, e.g., silicon, silica, silicon nitride for the ring resonators, splitters, and the frequency discriminator, while the optical source and the photodetectors may be realized in silicon, or any III-V platform. Such flexibility may enable customization of individual components of the sensor from a myriad of photonic platform to suit the requirements of the sensing application and/or environment.

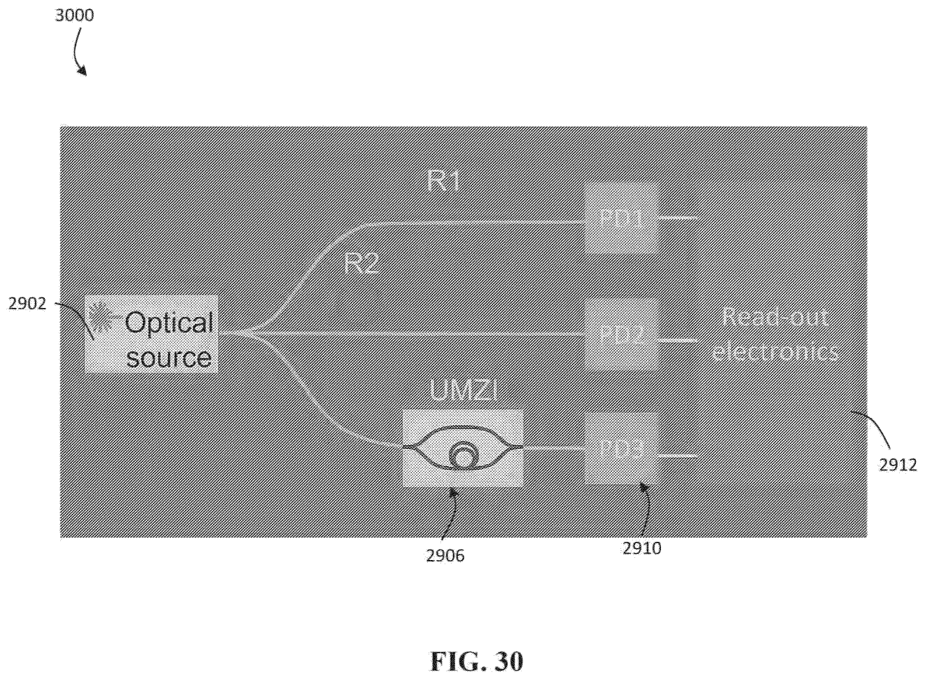

FIG. 30 depicts an example layout of the photonic biosensor 3000 with a single sensing element. This single, illustrative configuration may include two identical ring resonators R1, R2, an optical source 2902, a frequency discriminator 2906, PDs 2910, and read-out electronics 2912. In this example, the use of reference resonator element or elements (e.g., R2) may eliminate common-mode noise sources, e.g., thermal or vibration noise.

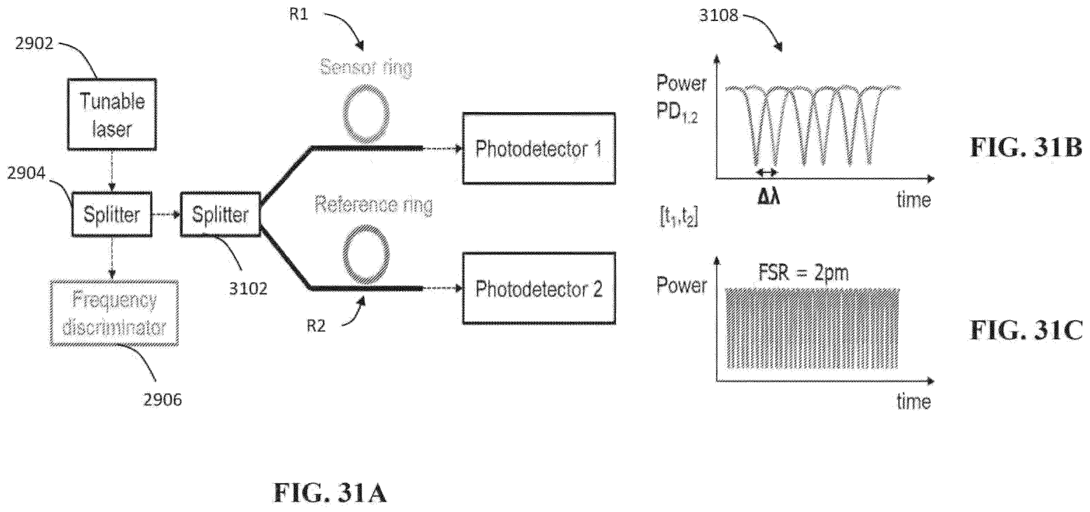

FIGS. 31A-31C illustrate the functionality of the sensing elements and frequency discriminator. FIG. 31A provides representation of the light source 2902 (e.g., a tunable laser) coupled to at least one splitter 2904. The first splitter splits the light between a frequency discriminator 2906 and a second splitter 3102. The second splitter 3102 provides the light to a first waveguide coupled to the sensor ring resonator R1 with an output fed to the photodetector (PD) 1. The light in the second waveguide is coupled to a reference ring resonator R2 with an output to the photodetector (PD) 2. FIG. 31B shows an example power spectra 3108 of the sensing elements and the frequency discriminator 2906 over time. The fringe pattern of the discriminator 2906 with the known free-spectral range may enable extraction of resonance wavelength shift due to the presence of analyte.

The optical source 2902 may be tuned across the resonances of the two identical ring resonators R1, R2 and an unbalanced MZI (UMZI)-based frequency discriminator 2906. A microfluidic channel may be employed to flow the to-be-sensed analyte on the sensor ring R1. The refractive index change resulting from the presence of the analyte on the surface of the sensor ring R1 may result in a relative shift of the resonance wavelengths between the two rings R1 and R2. This shift may be detected by PD 1 and 2, as illustrated in FIG. 31B. The resulting wavelength shift may scale with the components (e.g., biomarkers) and concentration of the analyte and may be extracted from the detector outputs.

The optical source 2902 in the sensor system may be a distributed feedback laser (DFB), a (sampled grating) distributed Bragg reflector laser (DBR laser), a vertical-cavity semiconductor emitting laser (VCSEL), a Vernier-tuned (VT) DBR laser, coupled ring-resonator laser (CRR), or any other laser diode configuration that is tunable thermally, electrically, mechanically, etc. across the ring resonances. The sensor system may account for the nonlinear tuning dynamics of the optical source 2902 (e.g., by using the output of a UMZI that has a known free-spectral range (FSR)). The relative movement of the output frequency of the source 2902 may then be evaluated (e.g., by using the spacing between the output fringes of the UMZI as shown in FIG. 31C).

The choice of the optical source 2902 may be determined by the required wavelength resolution for sensing, the material platform of the passive components, and/or the sampling rate of the read-out electronics 2912. The frequency drift of the optical source 2902 (e.g., laser) caused by the inherent white and flicker frequency noise components may lower the achievable wavelength resolution in the sampling period while the required relative-intensity-noise and the output power of the laser may be determined by the dynamic range of the electronics and the extinction ratio of the sensor element.

The optical splitter network 2904 depicted in FIG. 29 may be realized using any number of coupling systems (e.g., binary tree of directional couplers, multi-mode-interference couplers, etc.). The required flatness of the splitting ratio across the tuning range of the optical source may be determined by the thermal and/or nonlinear effects of the ring resonators or other sensor elements employed in the system. Improved compactness of the splitter network 2904 may be realized through implementation of a series of 1×N splitters comprising any number of coupling systems and/or coupler configurations including those described above. The optical splitter network 2904 can take any form and may be a combination of switches, wavelength multiplexing, and so on.

The frequency discriminator 2906 depicted in FIG. 29 can be used to evaluate the relative wavelength movement of the tuned optical source 2902. While the example of the discriminator depicted in FIG. 29 utilizes an unbalanced Mach-Zehnder interferometer (UMZI) configuration, other devices such as a stable Fabry-Perot cavity, a ring resonator, a gas cell, a free-space etalon, or any other reference cavity with a known free-spectral range and higher degree of thermal stability may be employed for clocking the read-out electronics as the source wavelength is tuned across the sensing element. In some embodiments, only the relative movement of source wavelength is of interest and the knowledge of absolute wavelength of source is not required, assuming the material and waveguide dispersion of the sensing element do not significantly vary the group index over the anticipated wavelength drift of the source and reference during the time of measurement.

### 3 Robotic Biosensor Systems

Robotic pipettors and similar machines have become widely available. Current automated liquid handling systems are most often used on simple pipetting workflows like well-plating, serial dilutions, etc. Incorporating automated liquid handling systems into more complicated chemical and biological processes is of significant interest. Further, to enhance these systems, an inexpensive, flexible, highly multiplexed manner of sensing performed reactions is beneficial. The present disclosure discusses a system in which a robotic chemistry and biology platform is integrated with integrated photonic sensors. This includes systems and methods for coupling automated systems with a photonics-based sensing platform to perform chemical and biochemical assays. Silicon photonics-based biosensors could be beneficial over currently used analytical methods for use in rapid, point-of-care medical diagnosis and other bioassays.

Example systems and methods related to automated testing and handling of test samples for a silicon photonics-based biosensing platform are described herein. In some examples, the automated biosensing system may include multiple tips, where each tip includes a disposable biosensor that broadly functions as described above. Individual test samples may be placed in individual wells of a multi-well plate. The automated system may then test multi-well plate test samples simultaneously by placing the biosensor-based tips directly into the well plate.

The advantages of system disclosed herein include that each chip may have many sensors that may be read simultaneously, allowing testing many analytes or testing the same analytes by using multiple sensing mechanisms. In addition, the readers disclosed herein are compact and have a lower cost due to a combination of chip-scale integration and leveraging of standard telecom/datacom components.

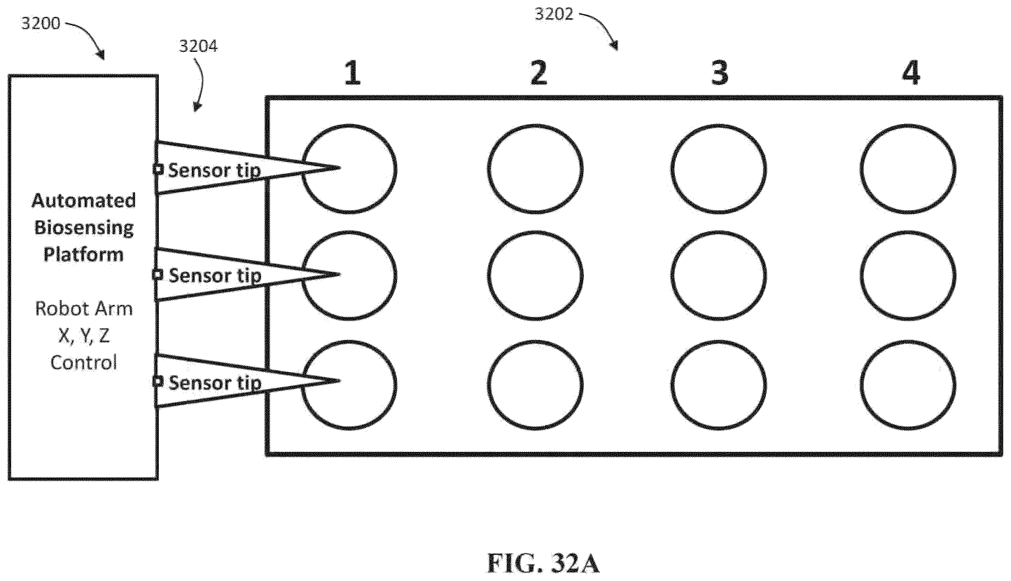

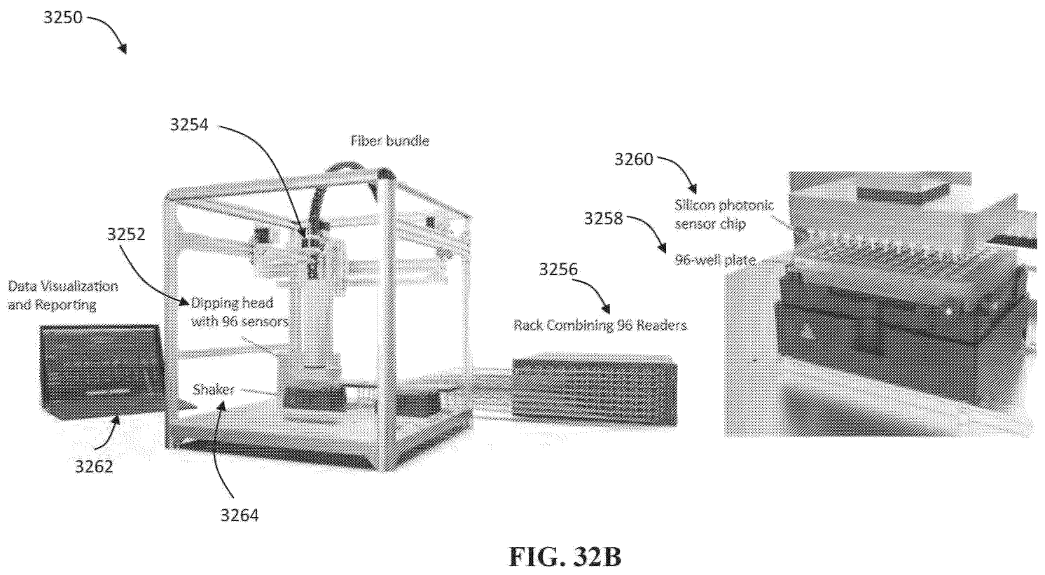

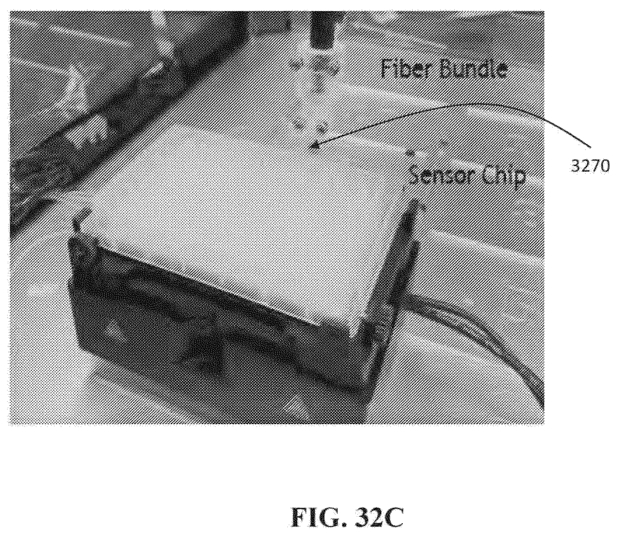

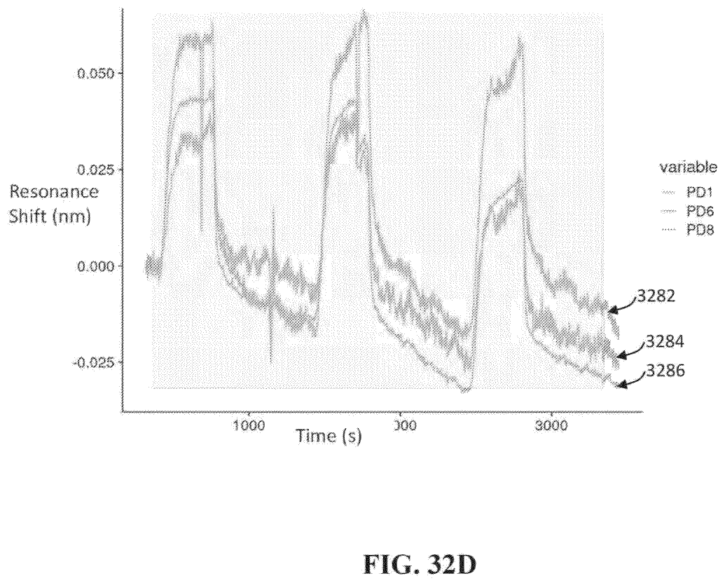

FIG. 32A illustrates an example automated biosensing system 3200 capable of performing multiple tests within a multi-well plate 3202 (or a single test in a single well plate). Individual biological test samples may be placed in individual wells of the multi-well plate 3202. The system 3200 can include multiple sensor tips 3204 including disposable sensors that are connected to reusable sensing components. Each disposable sensor can comprise a sensor chip as described above. Each sensor chip may include one or more optical analyte sensors. The automated system 3200 may test multi-well plate samples simultaneously (or near simultaneously) by placing the biosensor-based tips directly into the multi-well plate 3202.

FIG. 32B illustrates another example automated biosensing system 3250 that enables the sensor chips 3260 to be mounted onto a robotic dipping head 3252 (e.g., attached to a pipetting robot gantry 3254) and dipped into the wells of a multi-well plate 3258. This high-throughput platform combines a pipetting robot (e.g. Opentrons), a rack 3256 with numerous proprietary readers, and a 3252 dipping head that can pick up and discard numerous disposable photonic sensor chips 3260 simultaneously. For example, a standard shaker 3264 for a 96-well plate 3258 (or a plate with any other number of wells) agitation may be mounted under each 96-well sample plate in the pipetting robot. A user may build a protocol in the GUI interface and load a 96-well plate into the pipetting robot. At this point, the entire instrument may be autonomously performed with occasional plate reloading (this can be automated as well), which delivers enormous testing capacity.

In the above-described system, the centralized high-throughput platform can be considered as a 96x duplication of a single test that is integrated with a dipping head (such a configuration is shown in FIG. 32C, which shows a single sensor chip 3270 controlled by a pipetting robot). That is, the dipping head 3252 in the platform in FIG. 32B holds 96 disposable sensor chips, where the X-Y-Z motion of the dipping head 3252 is controlled by a pipetting robot gantry 3254. Since the sensor chips are dipped directly into wells of the 96-well plates, which brings the sensor chips into direct contact with the liquid samples in each well, there is no need for microfluidics for sample drawing, eliminating cost and complexity of the automated biosensing system while greatly increasing reliability.

In some embodiments, each reader module (or simply reader), within the rack 3256 with numerous proprietary readers, may interrogate a single sensor chip among the 96 disposable sensor chips held by the dipping head 3252. The rack 3256 is created to house the numerous proprietary readers (e.g., 96 readers), similar to those used in the datacenter industry for transceivers. Each reader module is connected to an optical fiber harness (e.g., via a pluggable multi-fiber push on (MPO) connector). The fiber harness mates to the dipping head, through the fiber bundle as illustrated in FIG. 32B, which may pick up and dip the disposable sensor chips simultaneously.

In some embodiments, the dipping head 3252 may contain a number (e.g., 96) of 16-fiber connectors (not shown) that each mates, via pluggable passive alignment, to sensor chips using alignment pins. In other embodiments, a number (e.g., 96) of 1×6 optical switch network chips (not shown) on the dipping head may be used instead to couple light into each sensor chip. This would allow time division multiplexing of optical readout, thereby expanding the number of sensors on each sensor chip. It is to be noted that the automated biosensing system disclosed herein is not limited to 96-well plate, 16-fiber connectors, or 1×6 optical switch network chip, but can be applied to x-well plate, y-fiber connector, and/or lxz optical switch network chips, where x, y, z can be another different number that is applicable to the disclosed automated biosensing system.

FIG. 32D is a graph illustrating the resonance shift for samples tested using one automated biosensing system disclosed herein. The data was obtained from continuous sensing of apolipoprotein A (ApoA) with ring resonators using the disclosed biosensing system. ApoA is a component of high-density lipoprotein (HDL). HDL is a molecule that transports cholesterol and certain fats called phospholipids through the bloodstream from the body's tissues to the liver. Once in the liver, cholesterol and phospholipids are redistributed to other tissues or removed from the body. HDL is often referred to as “good cholesterol” because high levels of this substance reduce the chances of developing heart and blood vessel (cardiovascular) disease, and thus monitoring of HDL is normally included in a blood test.

In the graph in FIG. 32D, the peak series 3286 and peak series 3284 correspond to the samples PD1 and PD6 respectively, while peak series 3282 corresponds to the sample PD6. PD1 and PD8 are a standard 2D surface that includes general biotin-streptavidin binding sites, while PD2 is a dextran-streptavidin 3D surface that includes more binding sites. From the peak series 3282, 3284, and 3286, it can be seen that the automated biosensing system disclosed herein can effectively monitor the HDL level of a patient from the human blood sample. The peak series 3282 for PD6 shows higher peaks mainly due to the more binding sites included in the dextran-streptavidin 3D surface.

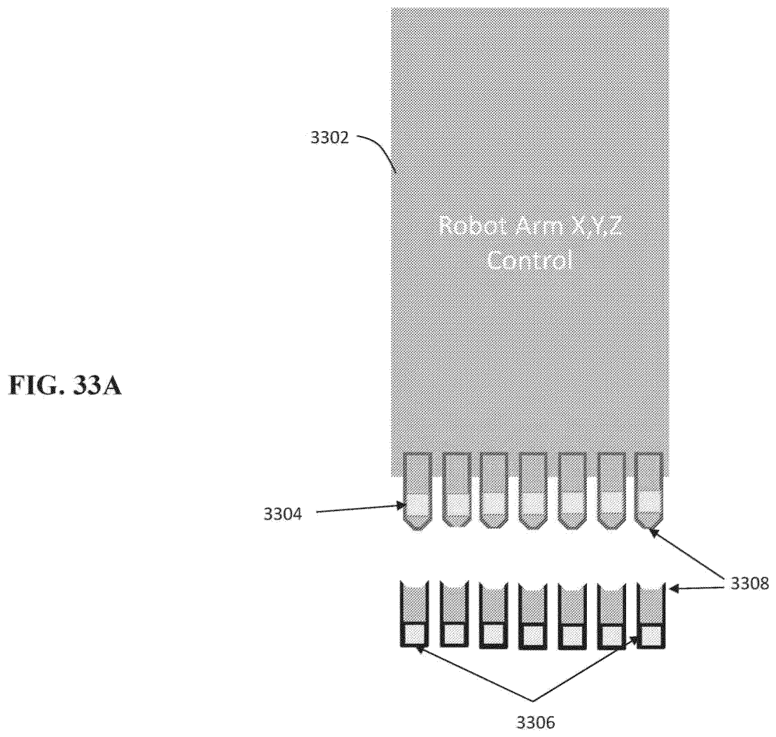

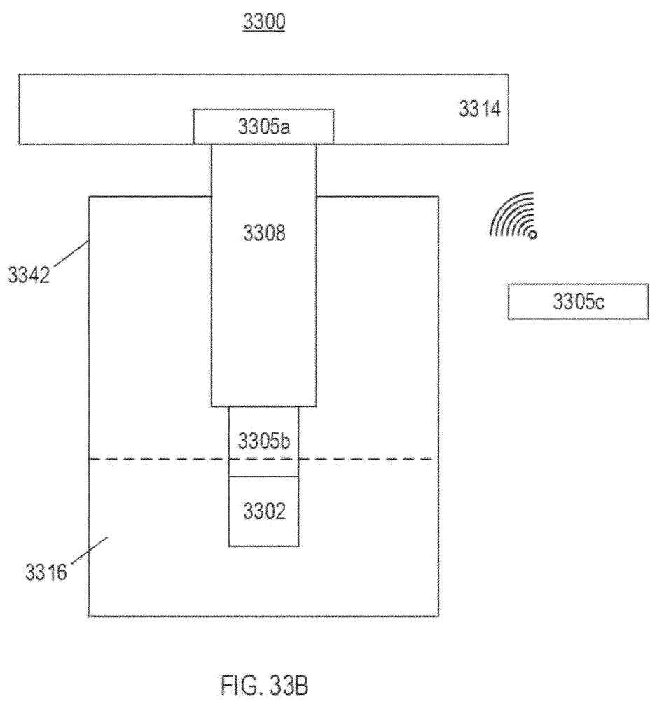

FIG. 33A illustrates mechanical alignment between a robot arm 3302 and a disposable sensor tip to enable optical communication between the reusable arm having reusable optical components 3304 and the disposable sensor chiplets 3306 on the sensor tips without necessarily including a microfluidic cell. Each disposable sensor chiplet 3306 may be a sensor chip described above. Each sensor chip may include one or more optical analyte sensors. A pluggable connector may connect the tip-based biosensor to reusable photonic chips or optical fibers within the automated biosensing platform. A chiplet with the connector may be also referred to as “cartridge,” which can be a cartridge containing one or more microfluidic cells as described earlier or can be a non-microfluidic cartridge. In some cases, there may be mechanical alignment features 3308 on the disposable tips that enable precise optical alignment between the sensor chips 3306 and the optics 3304 on the robot arm 3302. For example, the optics 3304 can include optical chip and/or fiber bundle (e.g., multi-fiber push on (MPO) connector). One potential advantage of this tip-based sensor and well-plate combination is the reduction of components in the biosensing platform. For example, instead of moving fluid around within the sensor via microfluidics, the tip-based sensors could be moved (via the robotic arm) to different wells containing different solutions (e.g., reference samples, test samples, sensor regeneration solutions, etc.).

The system may include one or more tunable lasers, single wavelength lasers, or broadband light sources that is coupled to the disposable sensors via a photonic chip and/or a fiber bundle (e.g., an MPO connector). The system may include switching optics such that light can be directed to different disposable sensors serially to increase intensity.

In some embodiments, the disposable tip-based biosensing chip may include multiple optical components (e.g., waveguides or optical fibers) that can be used to multiplex different tests (e.g., immunoassays, viral RNA/DNA, etc.) on the same test sample (e.g., in the same well). Redundant testing (e.g., for the same virus) may increase sensitivity and/or specificity, while multiplexing tests for multiple pathogens (e.g., COVID-19 and flu) and/or multiple patient samples may be advantageous for facile widespread testing. A coupled automated liquid handling architecture may allow these redundant and/or multiplexed tests to run more precisely and efficiently.

In some embodiments, the coupling automated liquid handling within the biosensing platform (e.g., via a robotic pipetting robot) may improve the accuracy and throughput of the photonics-based biosensing platform.

FIG. 33B illustrates an exemplary automated biosensing system 3300 with a single biosensor for illustrative purposes. As illustrated, the system 3300 may include an automated liquid handling system, which may include a gantry head 3314 and a dipping head 3308. An optical reader 3305a may be located in the gantry head or the dipping head. The optical reader 3305a may be optically coupled to a sensor chip 3302. The optical reader 3305a may include any components suitable for providing optical signals to the sensor chip 3302 and/or receiving and processing signals or data from the sensor chip 3302 (e.g., light source(s), photodetector(s), spectrometer, interferometer, microcontroller, processing device, etc.). The dipping head 3308 may be configured to dip the sensor chip 3302 into a sample 3316 contained within a well 3342 of a well plate.

The components included in a sensor chip 3302 can widely vary. The sensor chip 3302 may include one or more optical analyte sensors, which may be functionalized to detect levels of particular analytes. In some cases, the sensor chip 3302 may include an optical reader 3505b.

The optical reader 3305b may include any components suitable for providing optical signals to the sensor chip 3302 and/or receiving and processing signals or data from the sensor chip 3302 (e.g., light source(s), photodetector(s), spectrometer, interferometer, microcontroller, processing device, etc.).

The dipping head 3308 may provide a pluggable connection to the sensor chip 3302. In some embodiments, the pluggable connection may comprise a custom ferrule that uses precision holes to align to pins on the reader. For example, either waveguides in the sensor chip 3502 or fibers in the coupling component may align with the photonic components in the reader 3505a through the pluggable connection. In some embodiments, the pluggable connection may be a multi-fiber push on connector (MPO).

An example has been shown in which a portion of a reader system 3305a is co-located with the gantry 3314 or dipping head 3305, and a portion of a reader system 3305b is co-located with the sensor chip 3302. For example, the portion of the reader system 3305a may include a light source and the portion of the reader system 3305b may include a corresponding photodetector. Alternatively, the portion of the reader system 3305b may include the light source and the portion of the reader system 3305a may include the corresponding photodetector. In some embodiments, all optical components of the reader system are located on the portion of the reader system 3305b, while some or all electrical components of the reader system are located on the portion of the reader system 3305a. In some embodiments, the reader 3305a generates optical signals and provides them to the sensor chip 3302; the reader 3305b receives the optical signals provided by the sensor chip 3302, converts them into raw data, and sends the raw data to the reader 3305a or the reader 3305c; and the reader 3305 or 3305c processes the raw data to determine levels of target analytes sensed by the sensor chip.

Examples have been described in which portions of a reader system 3305 are co-located with the gantry or dipping head, co-located with the sensor chip 3302, or disposed remotely from the gantry, the dipping head, and the sensor chip (see reader 3305c). In some embodiments, the reader system 3305 may include an interrogator (or “optical reader”), which may provide optical signals to the sensor PIC 3302 and convert optical signals received from the sensor PIC into raw data. In some embodiments, the reader system 3305 may further include one or more processing devices (or computers) that analyze the raw data generated by the interrogator to determine one or more characteristics of one or more sensed analytes. Any suitable processing devices (or computers) may be used, for example, microprocessors or central processing units (CPUs)).

In some embodiments, the system 300 includes a shaker (not shown), which can shake each of the test samples. In some embodiments, the reader 3305 interrogates the one or more optical analyte sensors of the sensor chip 3302 while the sensor chip 3302 is dipped in the sample 3316 and while the shaker shakes the sample 3316. In some cases, the signals sensed by the optical analyte sensors may be stronger during the shaking, because the shaking may encourage interactions between binders and target analytes.

In some embodiments, the optical reader 3305a is optically edge coupled to an edge E of the sensor chip 3302, and the optical analyte sensors of the sensor chip 3302 are disposed on one or more surfaces of the sensor chip that are orthogonal to the edge E. This configuration may facilitate the use of non-microfluidic cartridges by making it possible for the optical analyte sensors to be directly immersed in the sample 3316 without relying on microfluidics to move the sample fluid onto the optical analyte sensors.

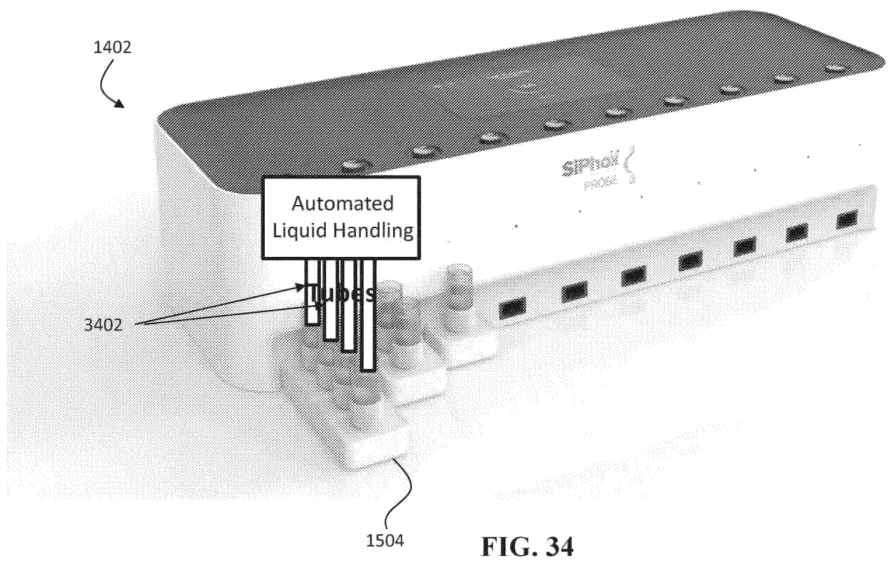

FIG. 34 illustrates an example implementation of an automated liquid handling (e.g., pipetting) mechanism to insert test samples directly into the disposable sensors. The automated liquid handling system is illustrated with reference to a tabletop biosensing platform 1402, as shown in FIG. 34. In the illustrated embodiment, tubes 3402 that carry analyte-test samples may be injected periodically into one or more input ports of disposable test cartridges 1504 (e.g. having one or more waveguide-based tests as described above) that are inserted into a tabletop biosensing platform 1402.

It is to be noted that while the automated liquid handling mechanism disclosed herein is illustrated with reference to a tabletop biosensing platform 1402, such automated liquid handling mechanism may be also integrated into the aforementioned automated biosensing system with a robotic pipetting robot, according to some embodiment.

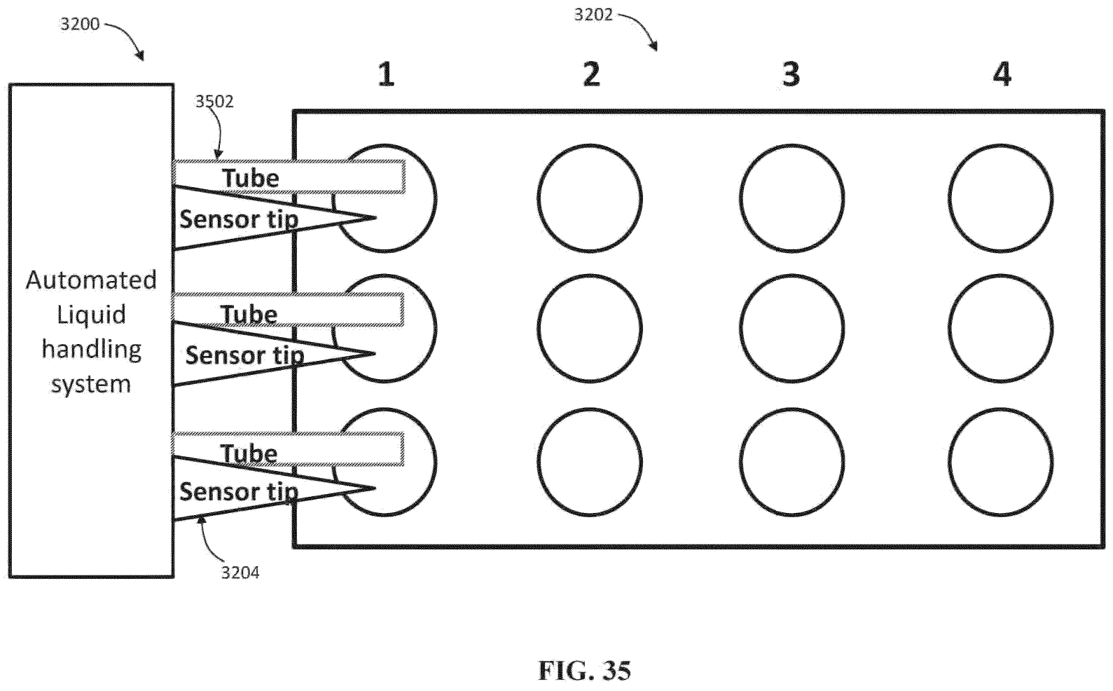

FIG. 35 illustrates an example implementation of an automated liquid handling system to draw samples into tubes and flow them over sensor chips via microfluidic channels. In this implementation, tubes 3502 may be coupled to a microfluidic system and the sensor tips as part of the automated liquid handling system 3200. These tubes 3502 can be placed into wells, e.g., in a 96-well plate 3202, and a robotic arm may be used to draw up reagents and/or samples. Suction may be provided by a peristaltic pump or syringe pump, or another source of negative pressure. In order to keep the samples from evaporating or interacting with the ambient air, a foil seal may be placed on the wells and a sharp point may be added to the tube 3502 or tube holder in order to pierce the foil and give the tube access to the sample.

Using automated liquid handling may improve precision and accuracy of injection volumes. In some cases, accurate and/or precise sample analyte volumes may improve the quantification of the biosensing target concentration. Additionally or alternatively, liquid handling may improve accuracy and/or precision of injection timing of sample analyte into the biosensing platform. This may also improve biosensing target concentration quantification and overall test accuracy.

For example, automated liquid handling may enable pooling test samples in series (e.g., samples are introduced to the biosensing platform at regular time intervals until a positive test is recorded). In particular, accurate and/or precise injection timing and volumes would be crucial in narrowing down the positive test sample. This may be performed using a disposable microfluidic cartridge that contains the sensor chip such that it can be portable and used in the field.

In some embodiments, the automated liquid handling system may include additional modules for thermocycling, PCR, heat blocks, fluorometers, shakers/mixers, chillers and other modules relevant for performing general biochemistry.

For example, the robotic dipping head system described above may be integrated with a shaker (e.g., shaker 3264 in FIG. 32B) in order to improve signal quality and system performance (e.g., faster response to binding via increased diffusion with shaking activated).

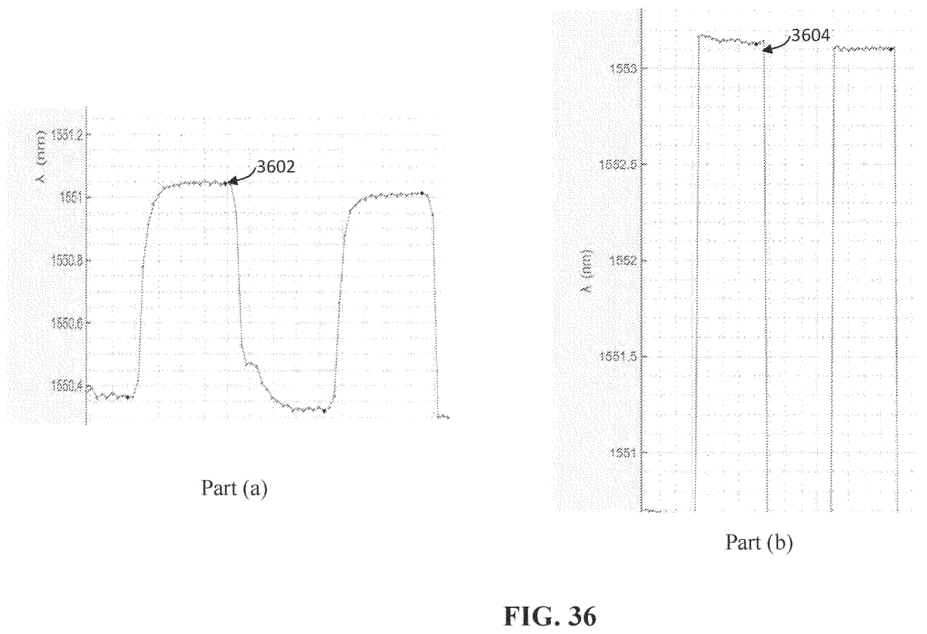

FIG. 36 shows data for a sample with (Part (b)) or without (Part (a)) shaking. In the disclosed automated biosensing system described above, the shaking may be activated with the sensor chips dipped into the samples. This allows a faster response to binding of analyte to binding ligands. In some embodiments, even if the sensor chips are not dipped into the samples during the shaking process, the improved signal quality may be still achieved due to the increased diffusion from the shaking. Part (b) of FIG. 36 shows the measured optical signal with shaking. As can be seen, the peaks in Part (b) have increased peak height and better peak separation when compared to the peaks in Part (a), which correspond to the samples without shaking.

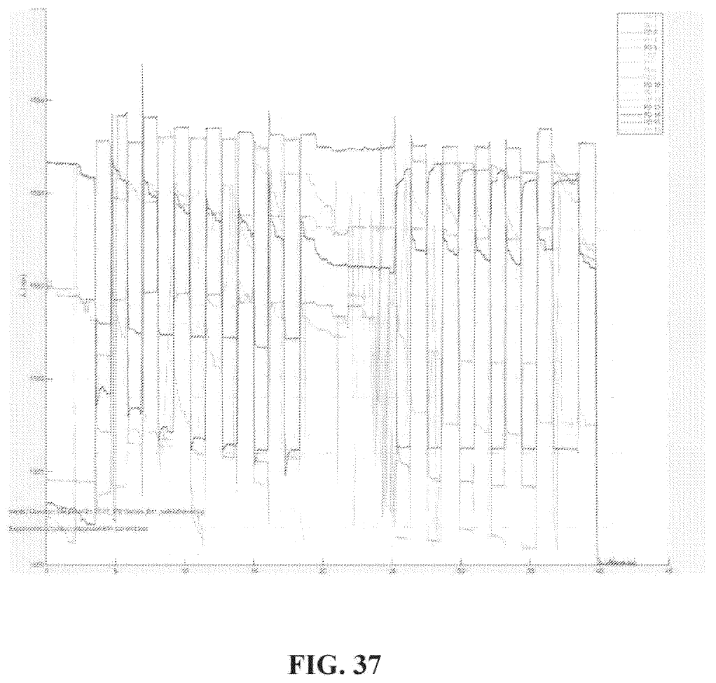

In some embodiments, the signal quality and system performance may be further improved by selecting proper solvents in preparing samples. For instance, biosensing signal characteristics (e.g. resonance peak shift) may be manipulated by changing optical characteristics of the solvent for preparing the sample. For example, as shown in FIG. 37, using deionized (DI) water versus salt water results in a blue shift of the resonance peaks due to the fact that DI water has a lower refractive index than salt water.

In some embodiments, the performance of the disclosed automated biosensing system can be further improved by including additional components. For instance, a device may be added to the system, in which the disposable sensor tips can be placed such that the user can pipette (by hand or via automated liquid handling) samples into wells, which can be then fed into droplet ejectors that apply drops to one or more sensors on the sensor chip within the disposable sensor tip. This may enable multiplexed functionalization of the chip, such that when it is used downstream in reactions, each sensor has been functionalized with a different protein or chemical. Each sensor chip design may include a matching functionalization cartridge design that couples it to the wells that are filled by the user. Thus, the user may add drops accurately to the surface as the cartridge and sensor chip holder are mechanically aligned to one another via alignment structures.

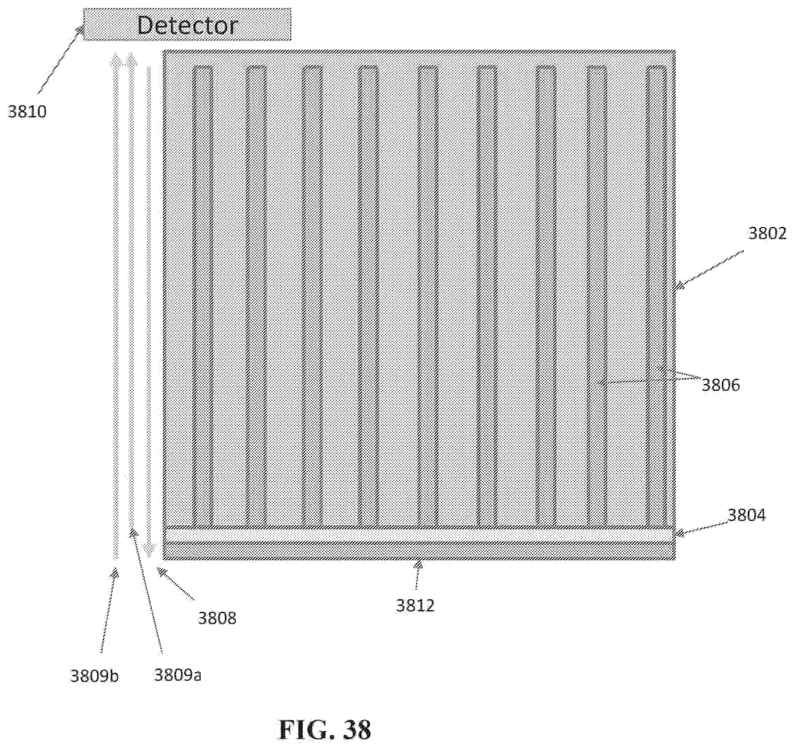

FIG. 38 illustrates a sensor chip with edge facets of waveguides used for biolayer interferometry. The sensor tips may include photonic chips where the waveguides terminating at the facet of the chip 3802 are coated with a thin layer of oxide 3804 or other material that has a different refractive index than the waveguide(s) 3806. The thin layer (e.g., oxide layer 3804) may be functionalized to facilitate photonic biosensing (e.g., via biolayer interferometry). For example, reflections of incoming coherent light 3808 may emerge from the interface between the waveguide and thin layer (e.g., silicon-oxide interface) and the oxide-biolayer-water interface. These reflections (e.g., reflection from first layer 3809a, reflection from second layer 3809b, etc.) may form interference patterns that can be measured via a detector 3810 configured to collect the back-reflections and/or record interference pattern. This may result in detector interference pattern or spectrum that shifts as the refractive index of the biolayer 3812 changes with binding/unbinding/cleavage of biomolecules.

The automated biosensing systems disclosed herein may be applied to test a large variety of biomolecules or other non-bio molecules, for diagnostic purpose, chemical analysis, or for many other different purposes. For example, by replacing disposable sensor chiplets that are functionalized with binding ligands for binding to different analytes without necessarily changing the reusable optical components, the automated biosensing systems can be easily used to test different analytes. In one example, the automated biosensing system disclosed herein may be utilized to measure concentrations of lipoprotein constituents in blood samples, so as to monitor cardiovascular health. The possible lipoprotein constituents measured by the automated biosensing system may include but are not limited to apolipoprotein A-1, where the concentration below 1.2-1.4 mg/mL may be reported as a risk factor, and Apolipoprotein B-100, where higher concentrations would indicate an increasing risk to users. By measuring these values using the disclosed automated biosensing system, users and healthcare providers can continuously monitor cardiovascular health progress caused by interventions such as dietary changes, exercise, and lipid-lowering agents.

In some embodiments, the disclosed automated biosensing system may be utilized to monitor liver functions, since there are many serum proteins in the liver that can be tested by the disclosed automated biosensing system, especially the system with sensor chips that can measure multiple analytes from a same sample (e.g., a same well).

In some embodiments, the disclosed automated biosensing system may be utilized to monitor kidney issues. For instance, impaired reabsorption of several serum proteins in the kidney may easily indicate kidney dysfunctions. The disclosed automated biosensing system may monitor beta-2-microglobulin, a protein >99% reabsorbed in the kidneys, where concentrations significantly below 200 ng/mL may indicate kidney dysfunction.

In some embodiments, one of the analytes that can be monitored by the disclosed automated biosensing system is total IgE. By tracking the total IgE, it is possible to predict increased risk of asthma attacks and other allergy related conditions. In some embodiments, the data measurement may be connected to an app that can recommend use of an inhaler or other suggestions (like avoiding allergens) if a problem is found.

In some embodiments, the disclosed automated biosensing system may be utilized to measure insulin resistance, detect prediabetic states earlier, or to inform users how their body responds to food. High insulin concentration is correlated to many diseases, so helping users decrease their insulin can be done by consistently monitoring insulin concentration via the disclosed automated biosensing.

It is to be noted that the above examples are provided for exemplary purposes and not for limitations. The disclosed automated biosensing system can be utilized to measure many other different biomolecules, including proteins, peptide, hormone, etc. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described components and systems can generally be integrated together in a single device or system or packaged into multiple devices or systems.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### 4 Terminology

The phraseology and terminology used herein is for the purpose of description and should not be regarded as limiting.

As used herein, “light” may refer to any optical signal of any suitable wavelength. Unless otherwise indicated, “light” is not limited to visible light.

The automated biosensing system described herein can be used to detect levels of any suitable analytes (e.g., proteins, hormones, small molecules, antibodies, aptamers, peptides, etc.).

A “linker” may tether an analyte, binder, label, or other molecule to a surface (e.g., the surface of a sensor chip). Any suitable linker may be used, e.g., a polymer (e.g., PEG), an aptamer, a protein, a peptide, a polysaccharide, a nucleic acid, a small molecule, a biotin streptavidin stackup or other linker based on biotin streptavidin, etc. A linker may have any suitable length. In some cases, a linker is long enough for a tethered, unbound label to be out of a sensor's zone of sensitivity (e.g., evanescent field). For example, a linker can be several hundred nanometers long or more. In some cases, a linker is short enough for a tethered label to be within a sensor's zone of sensitivity when a sandwich is formed. For example, a linker can be tens of nanometers long. In some examples, a linker comprises (i) a 2 megadalton or smaller dextran surface linker that enables a 3-dimensional structure to have more binding sites, or (ii) a DNA-origami 3-dimensional surface or other forest-like 3-dimensional structured surface configured to enhance the signal by making more binding sites available in the evanescent field.

As used herein, “real-time monitoring” (or “continuous monitoring,” “continual monitoring,” “real-time sensing,” or other similar phrases) may refer to any analyte monitoring or sensing technique in which the level of the analyte is sampled by a biosensor with a frequency no less than a specified minimum frequency (e.g., once per hour, once every 30 minutes, once every 15 minutes, once every 10 minutes, once every 5 minutes, once every minute, etc.).

The term “approximately,” the phrase “approximately equal to,” and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present In some embodiments, and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

A device, system or method may be consistent with any device, system or method disclosed in PCT Application No. PCT/US2022/037770 titled “INTEGRATED SILICON PHOTONIC BIOSENSORS FOR PLATE READERS, AND RELATED SYSTEMS AND METHODS” and filed Jul. 20, 2022, the entirety of which is hereby incorporated by reference.

What is claimed is:

1. An automated biosensing device, comprising:
a set of sensor units organized in an array, wherein each of the sensor units includes an optical reader optically coupled to a corresponding sensor photonic integrated circuit (PIC), wherein each sensor PIC comprises one or more optical analyte sensors each functionalized by a respective layer of binding ligands, and wherein each optical reader is configured to provide optical signals to the one or more optical analyte sensors of the corresponding sensor PIC; and
a robotic dipping head configured to dip each of the sensor PICs into a respective test sample.

2. The automated biosensing device of claim 1, further comprising a gantry head configured to control the dipping head to move in at least two dimensions.

3. The automated biosensing device of claim 2, wherein each of the optical readers is mounted on the gantry head.

4. The automated biosensing device of claim 2, further comprising a rack, wherein each of the optical readers is mounted on the rack.

5. The automated biosensing device of claim 1, wherein each of the optical readers is further configured to receive optical signals provided by the one or more optical analyte sensors of the corresponding sensor PIC via one or more optical fibers.

6. The automated biosensing device of claim 1, wherein:
the set of sensor units includes a particular sensor unit comprising a particular optical reader optically coupled to a particular sensor PIC having one or more particular optical analyte sensors; and
the particular optical reader is coupled to one or more processing devices configured to determine one or more characteristics of one or more analytes sensed by the one or more particular optical analyte sensors based on the optical signals provided by the one or more particular optical analyte sensors.

7. The automated biosensing device of claim 1, wherein:
each of the optical readers is a first optical reader; and
each of the sensor units further comprises a second optical reader co-located with the sensor PIC of the sensor unit.

8. The automated biosensing device of claim 7, wherein the set of sensor units includes a particular sensor unit comprising a particular first optical reader, a particular second optical reader, and a particular sensor PIC having one or more particular optical analyte sensors, and wherein the particular second optical reader is configured to:
receive optical signals provided by the one or more particular optical analyte sensors via one or more optical waveguides;
generate raw data based on the optical signals provided by the one or more particular optical analyte sensors; and
send the raw data to the first particular reader PIC.

9. The automated biosensing device of claim 8, wherein the second particular reader is configured to send the raw data to the first optical reader via one or more electrical wires.

10. The automated biosensing device of claim 1, further comprising a shaker configured to shake each of the test samples, wherein each of the test samples is disposed in a well of the well plate.

11. The automated biosensing device of claim 10, wherein each optical reader is configured to interrogate the one or more optical analyte sensors of the corresponding sensor PIC while the corresponding sensor PIC is dipped in the corresponding test sample and while the shaker shakes the corresponding test sample.

12. The automated biosensing device of claim 1, wherein:
the set of sensor units includes a particular sensor unit comprising a particular optical reader optically edge coupled to an edge of a particular sensor PIC; and
the one or more optical analyte sensors of the particular sensor PIC are disposed on one or more surfaces of the particular sensor PIC that are orthogonal to the edge of the particular sensor PIC.

13. The automated biosensing device of claim 1, wherein each of the sensor PICs is connected to the corresponding optical reader through a pluggable connector.

14. The automated biosensing device of claim 1, further comprising an automated liquid handing mechanism configured to inject the test samples into respective wells of a well plate.

15. The automated biosensing device of claim 1, wherein each of the sensor PICs is a component of a respective non-microfluidic cartridge.

16. A biosensing method comprising:
placing one or more test samples into one or more respective wells of a well plate;
with a dipping head of an automated biosensing device, dipping one or more sensor photonic integrated circuits (sensor PICs) into the one or more respective test samples, wherein each sensor PIC is optically coupled to a corresponding optical reader, wherein each sensor PIC comprises one or more optical analyte sensors each functionalized by a respective layer of binding ligands;
with each optical reader, interrogating the corresponding sensor PIC by providing optical signals to the one or more optical analyte sensors of the corresponding sensor PIC; and
for each sensor PIC, receiving optical signals provided by the one or more optical analyte sensors of the sensor PIC; and
determining one or more characteristics of one or more analytes sensed by the one or more optical analyte sensors based on the optical signals provided by the one or more optical analyte sensors.

17. The biosensing method of claim 16, wherein the optical signals provided by the one or more optical analyte sensors of the sensor PIC are received using one or more optical fibers.

18. The biosensing method of claim 16, further comprising, using a shaker, shaking each of the test samples.

19. The biosensing method of claim 16, wherein each optical reader interrogates the corresponding sensor PIC while the corresponding sensor PIC is dipped in a corresponding test sample and while the shaker shakes the corresponding test sample.

20. The biosensing method of claim 16, wherein placing one or more test samples into one or more respective wells of a well plate comprises, using an automated liquid handing mechanism, injecting the test samples into respective wells of a well plate.
